(19) United States
(12) Patent Application Publication
(10) Pub. No.: US 2025/0021828 A1
(43) Pub. Date: Jan. 16, 2025

(54) COMPUTER IMPLEMENTED METHOD FOR THE DETECTION OF ANOMALIES IN AN IMAGING DATASET OF A WAFER, AND SYSTEMS MAKING USE OF SUCH METHODS

(71) Applicant: Carl Zeiss SMT GmbH, Oberkochen (DE)

(72) Inventors: Anna Alperovich, Neu-Ulm (DE); Thomas Korb, Schwäbisch Gmünd (DE); Jens Timo Neumann, Aalen (DE); Abhilash Srikantha, Neu-Ulm (DE)

(21) Appl. No.: 18/830,054

(22) Filed: Sep. 10, 2024

Related U.S. Application Data
(63) Continuation of application No. PCT/EP2023/057880, filed on Mar. 27, 2023.
(60) Provisional application No. 63/324,258, filed on Mar. 28, 2022.

(30) Foreign Application Priority Data
May 25, 2022 (DE) 10 2022 113 352.4

(51) Int. Cl. G06N 3/0985; G06T 7/00

(52) U.S. Cl. CPC G06N 3/0985; G06T 7/001; G06T 2207/20081; G06T 2207/20084; G06T 2207/30148

(57) ABSTRACT

A computer implemented method for the detection of anomalies comprises: selecting an imaging dataset of a wafer and a hyperparameter value defining a machine learning model for anomaly detection; training and evaluating the machine learning model by computing an objective function value; and selecting one of the trained machine learning models and applying it to detect anomalies. A computer implemented method for the detection of anomalies in an imaging dataset of a wafer comprises: providing samples of a distribution of anomaly detection image values for each defect class; calibrating the anomaly detection image by training a machine learning model for anomaly localization; and applying a threshold to the calibrated anomaly detection image to detect anomalies.

### CROSS-REFERENCE TO RELATED APPLICATIONS

The present application is a continuation of, and claims benefit under 35 USC 120 to, international application No. PCT/EP2023/057880, filed Mar. 27, 2023, which claims benefit under 35 USC 119 of U.S. Provisional Application No. 63/324,258, filed Mar. 28, 2022, and German Application No. 10 2022 113 352.4, filed May 25, 2022. The entire disclosure of each of these applications is incorporated by reference herein.

### FIELD

The disclosure relates to computer implemented methods for the detection of anomalies in an imaging dataset of a wafer. The disclosure also relates to machine-readable hardware storage devices, to a system for controlling the production of wafers in a semiconductor manufacturing fab, and to a system for controlling the quality of wafers produced in a semiconductor manufacturing fab. The disclosure is not limited to computer implemented methods for wafers, it can be applied to any other manufactured object.

### BACKGROUND

Quality control (QC) is used in a production process for iteratively improving end-product quality. Due to its central role, it is desirable for QC techniques to be generic, efficient, and flexible, but also capable of adapting to altering production conditions and use-cases. Due to the lack of information about underlying defects, which can change with application or over time, QC systems are typically based on broad assumptions to cover all defect types. Thus, in general, QC-systems can address cold-starting conditions.

Cold-starting relates to the issue that a learning based system cannot draw any inferences for items about which it has not yet gathered sufficient information. This frequently occurs in the semiconductor industry, since production processes and wafer types are constantly adapted. Therefore, cold-starting is common in machine learning systems involving automated data modelling, since the machine learning models have to be trained again from scratch whenever system parameters are modified.

Unsupervised machine learning techniques, e.g., autoencoders, can successfully tackle the QC issue. During training, such techniques learn a compressed internal representation of the abundantly available “clean” or “defect free” data. As a result, the model is capable of perfectly reconstructing defect-free image samples. During testing, defects in input images might not be faithfully reconstructed. Spatial regions with high reconstruction error indicate outliers with respect to training data also known as anomalies. An anomaly is a localized deviation of the imaging dataset from an a priori defined norm, here the deviation from a normed semiconductor structure.

Yet, not all anomalies are defects: for instance, anomalies can also include, e.g., imaging artefacts, image acquisition noise, varying imaging conditions, variations of the semiconductor structures within the norm, rare semiconductor structures or variations due to imperfect lithography, varying manufacturing conditions or varying wafer treatment, etc. Such anomalies that are not defects but detected by some anomaly detection method are referred to as nuisance.

A machine learning model based on unsupervised learning elicits information solely from the data, without any human input, e.g., annotations, which can be effort intensive, noisy, or impractical. However, expert knowledge is still desirable to supervise the model training, i.e. for defining various model parameters called hyperparameters, e.g., the design of the model and its complexity (e.g., number of layers, number of filters per layer, size of the autoencoder bottleneck), its regularization (e.g., strategy and amplitude), data preprocessing techniques, dataset diversity and the learning strategy (e.g., learning rate and number of epochs). The expert selection of such hyperparameters is considered to obtain machine learning models of high quality.

In certain known technology, hyperparameter optimization methods were proposed to optimize hyperparameter values of a machine learning model by finding a set of optimal hyperparameter values minimizing the expectation of the validation loss of the machine learning model. Such a machine learning model, which is suitable for anomaly detection, is, for example, an autoencoder.

Hyperparameter optimization methods have been proposed, which automatically search for optimal hyperparameter values of the machine learning model. Among these, Neural Architecture Search (NAS) methods have been proposed, which automatically search for optimal hyperparameter values defining the architecture of neural networks.

Among these hyperparameter optimization methods, various techniques can be used for predicting good hyperparameter candidates as disclosed, for example, in “Max-value Entropy Search for Multi-Objective Bayesian Optimization; S. Belakaria, A. Deshwal, J. Doppa; Conference on Neural Information Processing Systems 2019”.

A known hyperparameter optimization framework called Optuna was, for example, disclosed in “Akiba, T., Sano, S., Yanase, T., Ohta, T. and Koyama, M., 2019, Optuna: A next-generation hyperparameter optimization framework, in Proceedings of the 25th ACM SIGKDD international conference on knowledge discovery & data mining, pp. 2623-2631”.

Another known method for hyperparameter optimization was, for example, disclosed in US 2020/0342329 A1. In this disclosure, algorithm hyperparameters of an autoencoder are optimized by evaluating the quality of the training progress, that is the history of the loss function values. The hyperparameter optimization method is unsupervised and does not use any labeled training data.

In US 2021/0256392 A1 another hyperparameter optimization approach was disclosed, in which hyperparameters are optimized by exploring a search space of hyperparameters and comparing the performance difference of corresponding anomaly detection networks. The application of the disclosed hyperparameter optimization methods to anomaly detection machine learning models is not straightforward. An anomaly detection model can be used to reconstruct the defect-free parts of the images well, e.g., via mean squared error loss (L₂ loss), but not the defects. Known hyperparameter optimization methods such as Optuna or the US 2020/0342329 A1 evaluate the machine learning models using the same metrics used during training of the models, which in most cases defaults to the L₂ metric, i.e., the mean squared error of the predictions. Optuna and similar known methods might not be suitable for defect or anomaly detection, as they would converge towards a perfect reconstruction of the input images including all possible defects, so anomaly or defect detection may not be feasible.

Machine learning models for anomaly detection often exhibit low precision rates due to noise and high nuisance rates, since not all anomalies are defects. Anomaly detection methods applied to imaging datasets of wafers can face the issue of a very high nuisance rate n, which is the inverse of the precision rate p, i.e., n=1−p, since far too many and mostly irrelevant deviations on wafer surfaces are discovered. Certain known anomaly detection methods involve extensive post-processing to be useful for defect detection on wafer surfaces. Many anomaly detection methods do not yield a pixel-accurate anomaly detection result.

An anomaly detection approach is disclosed in “Attention Guided Anomaly Detection and Localization in Images, S. Venkataramanan, K-C. Peng, R. V. Singh, A. Mahalanobis, ECCV 2020”. The proposed method therein is based on the idea of using an attention mechanism to differentiate between anomaly free areas and anomaly areas, so training of anomaly detection models can be carried out based on anomaly-free data yielding improved results. This approach is not applied to semiconductor images. The generated attention map is not considered to be pixel accurate and, thus, would not fulfill the high precision properties in the semiconductor field.

Another anomaly detection approach is disclosed in “ESAD: End-to-end Deep Semi-supervised Anomaly Detection, C. Huang, F. Ye, Y. Zhang, Y Wang, Q. Tian, Arxiv 2020.” The paper proposes a semi-supervised training of anomaly detection based on a small annotated dataset together with a large amount of unannotated data. The approach performs image-level anomaly detection indicating if an anomaly is present in the image without localizing it. This approach does not appear to fulfill the precision properties in the semiconductor field.

An approach for semantic segmentation is disclosed in “What's the point: semantic segmentation with Point Supervision; A. Bearman, O. Russakovsky, V. Ferrari, L. Fei-Fei; European Conference on Computer Vision 2016”. This approach deals with reducing the user effort during annotating images by indicating single points of objects instead of pixel-accurate segmentations.

Methods for the automatic detection of defects, which fulfill the precision properties in the semiconductor field, include anomaly detection algorithms, which are based on a die-to-die or die-to-database principle. The die-to-die principle compares portions of a wafer with other portions of the same wafer thereby discovering deviations from the typical or average wafer design. The die-to-database principle compares portions of a wafer with ideal simulated data from a database, e.g., a CAD file of the wafer, thereby discovering deviations from the ideal data.

For defect detection approaches like die-to-die or die-to-database the intermediate output generally is a difference image showing the difference between the expected image (the comparison dataset) and the actual image. The anomaly proposals are usually obtained by setting a threshold on the difference image. In this way, pixel-accurate anomaly detections can be obtained. Setting a threshold is a balancing act between maximizing capture rate (real defect flagged as anomaly) and minimizing nuisance rate (imaging artefacts, noise, uninteresting defects etc. flagged as anomalies). This step can be laborious, especially when defects with varying shape, size, and appearance are to be detected.

Traditionally, setting thresholds is a manual process where experts sieve through increasing thresholds. At each step, newly flagged anomalies are analyzed and threshold windows for various defect classes are selected. Alternatively, an expert provides a few annotations for each defect class to extract thresholds. Both exercises can be intensive search operations, and might be futile for low-contrast defects due to resulting high nuisance rates.

### SUMMARY

The disclosure seeks to improve anomaly detection within semiconductor wafers. The disclosure also seeks to improve the accuracy of machine learning methods for anomaly detection within semiconductor wafers. The disclosure further seeks to reduce a user interaction for the selection of hyperparameter values of machine learning models for anomaly detection. In addition, the disclosure seeks to provide an anomaly detection method including hyperparameter optimization. Also, the disclosure seeks to make hyperparameter optimization applicable to machine learning methods for anomaly detection. Further, the disclosure seeks to provide an evaluation metric for determining the performance of machine learning models for anomaly detection. Moreover, the disclosure seeks to provide an improved anomaly detection method, including an improved postprocessing method, for example an improved threshold setting method.

The disclosure addresses improving the accuracy of machine learning methods for anomaly detection, specifically for imaging datasets of wafers. Furthermore, the disclosure aims at improving the precision of machine learning approaches for anomaly detection without decreasing the recall.

According to a first embodiment of the disclosure, a method is provided to reduce the effort for the selection of hyperparameter values of a machine learning model for the detection of anomalies or defects in a semiconductor wafer. The method provides a method for automatic optimization of at least one hyperparameter value of a machine learning model thereby obtaining an optimized machine learning model for anomaly detection. A computer implemented method for the detection of anomalies according to a first embodiment of the disclosure therefore comprises
selecting an imaging dataset of a wafer
generating training data from the imaging dataset and
selecting an optimized machine learning model from one of at least two trained machine learning models based on the associated objective function value and
applying the optimized machine learning model to the imaging dataset of the wafer to detect anomalies,
   wherein the method step of selecting an optimized machine learning model comprises for each of the at least two trained machine learning models the steps of:
selecting a hyperparameter value from an associated set of hyperparameter values based on a sampling strategy, the hyperparameter value corresponding to at least one hyperparameter that defines a machine learning model for the detection of anomalies;
training a machine learning model controlled by the hyperparameter value on an input subset of the training data;
evaluating the trained machine learning model by computing an associated objective function value of an objective function.

By selecting the optimized machine learning model out of several different machine learning models, the accuracy of a method for anomaly detection can be increased. At the same time, the effort of a user for training the machine learning model can be reduced.

A computer implemented method for the detection of anomalies according to a second embodiment of the disclosure comprises:
selecting an imaging dataset of a wafer;
generating training data from the imaging dataset;
iterating the following steps:
   i. Selecting a hyperparameter value from an associated set of hyperparameter values, based on a sampling strategy, the hyperparameter value corresponding to at least one hyperparameter that defines a machine learning model for the detection of anomalies;
   ii. Training the machine learning model defined by the hyperparameter based on a subset of the generated training data;
   iii. Evaluating the trained machine learning model by computing an associated objective function value of an objective function.
selecting one of the trained machine learning models based on the associated objective function value and applying it to the imaging dataset of a wafer to detect anomalies.

By selecting one of the trained machine learning models based on the associated objective function value, the accuracy of the detected anomalies can be increased due to the optimized hyperparameters, e.g., the architecture, of the machine learning model. At the same time, the effort of a user for training the machine learning model is reduced. The trained machine learning model can be used for the detection of anomalies in an imaging dataset of a wafer. The imaging dataset can, for example, be acquired via a structured electron microscope.

In machine learning models, a hyperparameter is a parameter whose value is used to control the learning process, but is not learned from data. By contrast, the values of other parameters (typically node weights) are derived via training from training data. According to an example of the first or second embodiment, hyperparameters comprise at least one of a design hyperparameter, or an algorithm hyperparameter. Design hyperparameters refer to the design of the machine learning model. The design hyperparameters comprise all hyperparameters related to the architecture of the machine learning model, e.g. the number of layers, the size of layers, the type of layers, the size of filters, kernel sizes of convolutional layers, the type of convolution used, the up-sampling scheme, the connections between the layers, the bottleneck size, the bottleneck filter size, etc. An example of a model or design hyperparameter is the topology and size of a neural network. Algorithm hyperparameters generally have no influence on the performance of the model but affect the speed and quality of the learning process. Examples of algorithm hyperparameters are learning rate, mini-batch size, drop-out rate, size and content of the training dataset, type of loss function. A further example of an algorithm hyperparameter is the optimization algorithm used (stochastic gradient descent, Adam, RmsProp, etc.).

According to the first or second embodiment, the at least one hyperparameter defining the machine learning model for the detection of anomalies can include at least one of the following examples, but is not limited to these:

### Design Hyperparameters:

the bottleneck size
the bottleneck filter size (number of features in the bottleneck),
the initial filter size (number of filters in the first layer of the network, the other network features are scaled proportionally to the first layer),
the type of convolution used,
the up-sampling scheme,
the connections between the layers,
the number of layers in the model,
the size of layers in the model,
the type of layers in the model,
the filter size,
kernel sizes of convolutional layers,

### Algorithm Hyperparameters:

type and/or parameters of the loss function
the initial learning rate,
the learning rate decay factor,
utilization of momentum,
the number of epochs,
the regularization scale,
the size and content of the training set (number of images),
samples that represent the dataset,
the drop-out rate,
utilization of Nesterov accelerated gradient,
type of optimization algorithm,

In an example according to the first or second embodiment, the method according to the first or second embodiment further comprises a step of selecting a plurality of hyperparameters that jointly define the machine learning model for the detection of anomalies. With each selected hyperparameter, a set of associated hyperparameter values is selected. At least one hyperparameter to be optimized can be related to the design of the machine learning model.

In an example of the method according to the first or second embodiment, the step of generating training data comprises expert annotations of anomalies for a subset of the imaging dataset. Thereby, objective functions suitable for selecting an optimized machine learning model or for hyperparameter optimization can be defined.

According to an example of the first or second embodiment, the subset of the training data contains a number of samples of the training data. It can also contain the whole generated training data. The size of the subset of the training data can increase with the number of iterations, thereby reducing computation time.

In an example of the method according to the first or second embodiment, the input data of the machine learning model and the training data can include (e.g., consist of) tiles of a specific size of the imaging dataset. In an example according to the first or second embodiment, tiles (e.g., 2-D images or 3-D voxel arrays) are extracted from the imaging dataset and input to the machine learning model. Tiles can include a sufficient spatial context of the anomaly to be detected. In an example according to the first or second embodiment, tiles are at least as large as the expected anomaly and also incorporate a spatial neighborhood context.

In an example according to the first or second embodiment, an autoencoder model is selected as machine learning model, wherein the autoencoder machine learning model is trained to compute a reconstructed subset of the imaging dataset of a wafer without anomalies.

An autoencoder machine learning model is an unsupervised machine learning method involving a minimum amount of user input. An autoencoder model is a type of artificial neural network used in unsupervised learning to learn efficient codings of unlabeled data. An autoencoder comprises two main parts: an encoder that maps the input into a code; and a decoder that maps the code to a reconstruction of the input. The encoder neural network and the decoder neural network can be trained so as to minimize a difference between the reconstructed representation of the input data and the input data itself. The code can be a representation of the input data with lower dimensionality and can, thus, can be viewed as a compressed version of the input data. In an example according to the first or second embodiment, autoencoders are forced to reconstruct the input approximately, preserving only the most relevant aspects of the data in the reconstruction. Therefore, autoencoders can be used for the detection of anomalies. Anomalies generally concern rare deviations from the norm within an imaging dataset. Due to the rarity of their occurrence, the autoencoder will not reconstruct this kind of information, thus suppressing anomalies in the imaging dataset.

In an example according to the first or second embodiment, during the step of anomaly detection according to the first or second embodiment, the anomalies within the imaging dataset are detected based on a comparison between the imaging dataset and a comparison dataset. The comparison dataset comprises information making the detection of anomalies possible when compared to the imaging dataset. In an example according to the first or second embodiment, the comparison dataset comprises the reconstructed imaging dataset, which is ideally defect-free. In an example according to the first or second embodiment, the reconstructed imaging dataset is reconstructed via an autoencoder or via principal component analysis. In an example according to the first or second embodiment, the anomaly detection is performed using a distance metric or a threshold operation applied to the comparison dataset.

Anomalies can then be detected by comparing the imperfect reconstruction of imaging dataset to the original imaging dataset. Any difference between an input image and the reconstructed representation of the input image indicates an anomaly. A distance metric between the input image and the reconstructed representation of the input image can be used to quantify whether an anomaly is present. The larger the difference between them, the more likely an anomaly is contained in the tile. The detection of an anomaly can include the application of one or more thresholds to the difference image of the original and the reconstruction image. In an example according to the first or second embodiment, local thresholds can be applied to a subset of a difference image. Further measurements can also be used for the detection of anomalies, e.g., the size, location or shape of the differences or their local distribution. Thereby, defects of interest are detected while deviations due to noise are suppressed.

In an example according to the first or second embodiment, the method for the detection of anomalies further comprises the steps of defining the objective function suitable for selecting an optimized machine learning model or for hyperparameter optimization. The objective function according to the example can comprise at least one model evaluation metric.

A model evaluation metric is a quantifiable expression measuring properties of the trained machine learning model and can comprise the measuring of at least one of the properties referring to the performance of the trained machine learning model, the quality of the anomaly detections, the complexity of the trained machine learning model, the effort or cost for applying the trained machine learning model, etc. In an example according to the first or second embodiment, multiple model evaluation metrics can be defined and combined suitably within the objective function. In an example, previously generated validation data is provided for evaluating a model evaluation metric.

In an example according to the first or second embodiment, the objective function comprises at least two model evaluation metrics. A method using an objective function comprising at least two model evaluation metrics can be applicable to anomaly detection, since the combination of different model evaluation metrics prevents the reconstruction of defects by a trained machine learning model, e.g. an autoencoder, making sure that the comparison dataset sufficiently deviates from the imaging dataset in case of defects. In this way, human effort can also reduced, the performance of the anomaly detection can be maximized, and the quality, reproducibility and stability of the results can be improved. In addition, cold-starting can be made possible.

The objective function is a measure for the quality of a trained machine learning model and, thus, a measure for the quality of the hyperparameter values selected for this model. Applying an objective function comprising at least two different model evaluation metrics can help make sure that the optimization of the hyperparameter value according to the first or second embodiment does not yield a perfect reconstruction of the training data including the anomalies, since all model evaluation metrics are computed simultaneously and, thus, contribute to the objective function value of the objective function.

The objective function for hyperparameter optimization can comprise or be the loss function used during training of the machine learning model as model evaluation metric. A model evaluation metric can also comprise or be an Lp-norm loss function, p≥1, e.g. an L₂ loss function. The Lp-norm loss function can measure the deviation of the training data samples from corresponding target data samples, for example the deviation of the training data samples from their anomaly-free reconstruction, for example the deviation of the training data samples from their reconstruction by an autoencoder. This ensures a correct reconstruction of anomaly-free image regions and, thus, yields improved anomaly detection results.

In an example according to the first or second embodiment, at least one of the model evaluation metrics comprises a discriminative loss function evaluating the difference between expert annotations of the anomalies and the detected anomalies. The expert annotations comprise labels assigned to pixels or regions in the imaging dataset, the labels indicating, e.g., anomaly or no-anomaly. The objective function can, thus, also or alternatively comprise a discriminative loss L_{CE} of defect/non-defect using a few pixelwise annotations provided by an expert user. In an example according to the first or second embodiment, the difference between the original and the encoded samples (original−encoded) is retained as a continuous value but clipped in the range (0, 1). This value is directly compared with the binary labels (anomaly/no-anomaly) through a cross entropy loss. Note that the provided examples do not need to encompass all defects in the dataset. Optionally, less than 10%, such as less than 1%, of the training data are expert annotations. In addition, the expert annotations assign labels only to a subset of the anomalies present in the imaging dataset and/or to a subset of the types of anomalies present in the imaging dataset. In this way, expert user input is minimized and cold-starting is made possible, since no expert user annotations are specifically required if new defects occur in an imaging dataset. It should also be noted that these amounts of training data would not be sufficient to train a stand-alone model.

According to an example according to the first or second embodiment, the expert annotations can be provided via multiple formats (e.g., bounding box, click points, auxiliary process information etc.), with the discrimination loss (L_{CE}) adapted accordingly. E.g., bounding box annotations are associated with an overlap metric, i.e., intersection-over-union loss L_{IOU}.

In an example of the first or second embodiment of the disclosure, the expert annotations are given, e.g., as pixelwise annotations or as bounding boxes. These expert annotations are facilitated using expert knowledge, e.g. based on the critical distance, critical dimension or pitch size, which are related to the minimum size of structures on the wafer. In this way, it can suffice for an expert to simply click in the center of a defect in the imaging dataset and a larger region corresponding to the critical distance, critical dimension or pitch size is automatically assigned as defect around the click point.

To avoid overfitting, one of the model evaluation metrics can further comprise a measure of the complexity of the machine learning model, e.g. an Occam-razor penalty for complexity of the machine learning model. This model evaluation metric considers the total number of floating-point operations (L_{FLOP}) in one forward-pass of the machine learning model, e.g., the logarithm of this number. Alternatively, the number and/or size of the layers of a trained neural network and/or the number of connections between the neurons and or other suitable hyperparameter values could be used by a model evaluation metric for measuring the complexity of the machine learning model.

In an example of the first or second embodiment of the disclosure, the training data comprises expert annotations of anomalies for subsets of the imaging dataset, and the objective function comprises a weighted sum of an Lp-norm loss function, p≥1, measuring the deviation of the training data samples from corresponding target data samples (e.g., the deviation of the training data samples from their autoencoder reconstruction) and a discriminative loss function evaluating the difference between model predictions and expert annotations of anomalies. Considering this specific combination of model evaluation metrics ensures anomaly detection results of very high accuracy, since simultaneously 1) the accuracy of predictions for anomaly-free data is evaluated (Lp-norm loss), 2) the accuracy of predictions for anomalous data is evaluated (discriminative loss), 3) class-imbalancing is prevented due to the specifically selected expert annotations for anomalies.

In an example of the first or second embodiment of the disclosure, the training data comprises expert annotations of anomalies for subsets of the imaging dataset, and the objective function comprises a weighted sum of an Lp-norm loss function, p≥1, measuring the deviation of the training data samples from corresponding target data samples (e.g., the deviation of the training data samples from their autoencoder reconstruction), a discriminative loss function evaluating the difference between expert annotations of the anomalies and model predictions and a measure of the complexity of the machine learning model. Considering this specific combination of model evaluation metrics ensures anomaly detection results of especially high accuracy, since simultaneously 1) the accuracy of predictions for anomaly-free data is evaluated (Lp-norm loss), 2) the accuracy of predictions for anomalous data is evaluated (discriminative loss), 3) class-imbalancing is prevented due to the specifically selected expert annotations for anomalies, and 4) overfitting is prevented (complexity measure). In an example, the objective function comprises a weighted sum of three model evaluation metrics, e.g.,

f=w₁L₂+w₂L_{CE}+w₃L_{FLOP}

where the weights w₁, w₂, w₃ can be configured by a user. Typically, the first two weights are of similar magnitude whereas the third is at least ten times lower, e.g., w₁=10, w₂=1, w₃=0.01. One or more of the weights could also be set to 0, e.g. w₃ could be 0, so the objective function would not penalize the complexity of the model. Instead of the L₂-norm any other Lₚ-norm could be used. The discriminative loss function L_{CE} could be replaced by any loss function penalizing the deviation of the difference image and some groundtruth data for anomalies in the imaging dataset, e.g. an intersection over union loss L_{IOU}. Additional model performance metrics can be added as well. In addition, other options of the Optuna library can be selected.

In an example according to the first or second embodiment, the objective function also or alternatively to any of the terms above comprises a quality value as model evaluation metric in order to evaluate the quality of the trained machine learning model, wherein a user interface is configured to present information on the trained machine learning model to a user and let a user indicate the quality value. The information presented to a user could comprise the precision rate, the recall rate, sample anomaly detections, hyper parameter values associated with the trained machine learning model, e.g. the design of the model, filters learned by the model for one or several of its layers, etc. If the objective function is minimized, the user can select a low value as quality value if the quality of the trained machine learning model is high. The user can select a high value as quality value if the quality of the trained machine learning model is low.

In an example according to the first or second embodiment, the hyperparameter value is selected according to a sampling strategy determining, based on previously selected hyperparameter values and associated objective function values, which hyperparameter value should be selected next. In an example according to the first or second embodiment, the sampling strategy comprises the use of a sampling algorithm.

An example of a sampling strategy comprises a tree-structured Parzen estimator (TPE), which handles categorical hyperparameters in a tree-structured fashion. For instance, the number of layers of a neural net and the number of neurons in each define a tree structure. For example, there cannot be a third layer if the second one is not there and setting the number of neurons only makes sense if this layer exists in the graph. Another example is the choice of the optimizer of the machine learning model, since each optimizer can have its own set of parameters.

The sampling strategy for selecting hyperparameter values can comprise taking into account hyperparameter values and corresponding values of the objective function from one or more previous iterations by optimizing one criterion selected from the group comprising expected improvement, maximum probability of improvement, upper confidence bound. In this way, the performance of the method of selecting the optimized machine learning model is improved and anomaly detection results are improved.

According to an example of the first or second embodiment, the method further includes the evaluation of an improvement acquisition function. The acquisition function is a surrogate model of the validation loss as a function of the hyperparameter values, which can be fit to the previous obtained objective function values, also called previous observations, and is configured to predict where the local optimum of the objective function might be. These methods are further called Sequential Model-Based Optimization (SMBO). The surrogate model can serve at least as a part of the objective function. The use of surrogate models simplifies the evaluation of the objective function and reduces computation time, since the costly step of evaluating the objective function is carried out less often.

For instance, one can use the Probability of improvement (PI) as an improvement acquisition function, which evaluates the objective function f at the point most likely to improve upon this value. The objective function f is to be minimized. Let f′ denote the minimal value of f observed so far and D the previous observations, i.e. the previously obtained objective function values. Then this corresponds to the following utility function associated with evaluating f at a given point x (corresponding to a set of hyperparameters):

$$u ( x ) = \{ \begin{matrix}0 , f ( x ) > {f}^{′} \\ 1 , f ( x ) \leq {f}^{′}\end{matrix}$$

The probability of improvement acquisition function is then the expected utility as a function of x:

$${a}_{PI} ( x ) = E [ u ( x ) \vert x , D ] = {\int }_{- ∞}^{{f}^{′}} ( f ; μ ( x ) , K ( x , x ) ) df = Φ ( {f}^{′} ; μ ( x ) , K ( x , x ) )$$

where N denotes the density of the normal distribution, Φ the cumulative distribution function of the normal distribution and K(x,x) its variance. The point x with the highest probability of improvement (the maximal expected utility) is then selected as next hyperparameter value for evaluation.

An alternative improvement acquisition function that does account for the size of the improvement is the expected improvement (EI). Expected improvement evaluates f at the point that, in expectation, improves upon f′ the most. This corresponds to the following utility function:

$$u ( x ) = max ( 0 , {f}^{′} - f ( x ) ) .$$

The expected improvement acquisition function is then the expected utility as a function of x:

$${a}_{EI} ( x ) = E [ u ( x ) \vert x , D ] = {\int }_{- ∞}^{{f}^{′}} ( {f}^{′} - f ) ( f ; μ ( x ) , K ( x , x ) ) df = ( {f}^{′} - μ ( x ) ) Φ ( {f}^{′} ; μ ( x ) , K ( x , x ) ) + K ( x , x ) ( {f}^{′} ; μ ( x ) , K ( x , x ) ) .$$

The point with the highest expected improvement (the maximal expected utility) is selected. The expected improvement has two components. The first can be increased by reducing the mean function μ(x). The second can be increased by increasing the variance K(x; x). These two terms can be interpreted as explicitly encoding a tradeoff between exploitation (evaluating at points with low mean) and exploration (evaluating at points with high uncertainty). The exploitation-exploration tradeoff is a classic consideration in such issues, and the expected improvement criterion automatically captures both as a result of the Bayesian decision theoretic treatment.

An alternative improvement acquisition function is typically known as upper confidence bound (UCB). It is typically described in terms of maximizing f rather than minimizing f; however in the context of minimization, the improvement acquisition function takes the form

$${a}_{UCB} ( x ; β ) = μ ( x ) - β σ ( x )$$

where β>0 is a tradeoff parameter and σ(x)=\sqrt{K(x, x)} is the marginal standard deviation of f(x). In the context of minimization, this is better described as a lower confidence bound. Again, the UCB acquisition function contains explicit exploitation μ(x) and exploration σ(x) terms. The iterative application of this UCB acquisition function will converge to the true global minimum of f.

For each of the sampling strategies described, at least one set of hyperparameter values can be associated with a probability distribution indicating the likelihood for each hyperparameter value for being selected by the sampling strategy. The probability distribution can be predefined and, thus, independent of the objective function values. The probability distribution indicating the likelihood for each hyperparameter value for being selected by the sampling strategy can be modeled based on application based prior knowledge, such as based on imaging hardware settings or design knowledge such as critical distance. In this way, prior knowledge on parameter spaces can be integrated into the method step of selecting an optimized machine learning model of the first embodiment or the steps of the iteration of the second embodiment. Thus, anomaly detection results are improved since the sampling strategy is improved and computation time can be reduced.

In an example, the sampling strategy comprises at least two different sampling strategies for the at least two trained machine learning models of the first embodiment or for the machine learning models trained during the steps of the iteration of the second embodiment, leading to improved results due to a more thorough exploration of the hyperparameter value space.

Optionally, the steps comprised for selecting an optimized machine learning model according to the first embodiment or the steps of the iteration of the second embodiment comprises a pruning strategy, e.g. comprising a pruning algorithm, that decides whether the training of a given machine learning model should be continued or interrupted. In an example, the pruning strategy comprises an early stopping criterion. In a further example, the pruning strategy comprises an asynchronous successive halvings strategy. In a further example, the machine learning models generated by sampling a set of hyperparameter values can be first tested based on the objective function for a small subset of the training data samples. In case of a low performance, the sampled hyperparameter values can be discarded early, otherwise the size of the subset of the training data can be increased. This pruning strategy reduces computation time. By applying a pruning strategy, hyperparameter values are tested and discarded early if the objective function does not show good results. Thus, computation time is saved and the method made applicable for cold-starting scenarios, where re-training is often involved.

According to a third embodiment of the disclosure, a computer implemented method for the detection of anomalies in an imaging dataset of a wafer is provided, wherein the imaging dataset comprises defects belonging to a number of defect classes. The method comprises the steps of
generating an anomaly detection image by applying an anomaly detection method to an imaging dataset;
performing one or more iterations, at least one of them comprising the following steps
   i. Providing one or more samples of a distribution of anomaly detection image values for each defect class of a subset of the defect classes;
   ii. Calibrating the anomaly detection image via at least one calibration method comprising the following steps:
      a. Training a machine learning model for anomaly localization, such as anomaly segmentation, based on the one or more samples of the distribution of the anomaly detection image values;
      b. Applying the trained machine learning model to the anomaly detection image to obtain the calibrated anomaly detection image;
applying a threshold to the calibrated anomaly detection image to detect anomalies, thereby reducing nuisance and highlighting defects in the anomaly detection image.

In a fourth embodiment of the disclosure, a computer implemented method for the detection of anomalies in an imaging dataset of a wafer is provided, wherein the imaging dataset comprises defects belonging to a number of defect classes.
generating an anomaly detection image by applying an anomaly detection method to an imaging dataset;
providing one or more samples of a distribution of anomaly detection image values for each defect class of a subset of the defect classes;
detecting anomalies within the anomaly detection images with at least one calibration method, comprising the steps of:
   training a machine learning model for anomaly localization, such as anomaly segmentation, based on the one or more samples of the distribution of anomaly detection image values;
   applying the trained machine learning model to the anomaly detection image to obtain the calibrated anomaly detection image;
   applying a threshold to the calibrated anomaly detection image to detect anomalies, thereby reducing nuisance and highlighting defects in the anomaly detection image.

The method according to the third or fourth embodiment of the disclosure makes machine learning methods for anomaly detection even more applicable to defect detection, since it involves only a minimal amount of user input, thereby concurrently reducing the nuisance in anomaly detection images and highlighting the anomalies or defects. Based on such an enhanced or calibrated anomaly detection image, it is possible to robustly detect anomalies by applying only a single threshold.

According to an aspect of the third or fourth embodiment, the method further comprises the step of automatically setting the threshold by using available side information (e.g. information related to the size of wafer structures such as critical distance, critical dimension, pitch size etc.) or by providing annotated defects of at least a subset of the defect classes. To this end, a method according to the third or fourth embodiment relates to workflows for a solution which is robust to defect size and/or contrast and calibrates anomaly detection images, e.g., difference images, to highlight defects of interest while suppressing those due to noise.

The notion “anomaly localization” refers to any method computing the location of an anomaly, e.g. an anomaly segmentation method, a semantic anomaly segmentation method, an anomaly detection method, a classification method, a regression method, a method for finding out of distribution samples etc.

The number of defect classes can relate to a single defect class, to several defect classes or to all defect classes occurring in an imaging dataset.

The notion “anomaly detection image” refers to the output of an anomaly detection method in the form of an image indicating anomalies, e.g. by pixel-wise labeling or bounding-boxes etc. In an example of the third or fourth embodiment, the anomaly detection image is a difference image of the imaging dataset and a comparison dataset, e.g. a reconstruction of the imaging dataset. In an example, the comparison dataset is based on a die-to-die principle or on a die-to-database principle.

In an example of the third or fourth embodiment, the comparison dataset can comprise a reconstructed representation of the imaging dataset generated by training a machine learning autoencoder on the imaging dataset or a subset thereof and applying the trained autoencoder to the imaging dataset to obtain the reconstructed imaging dataset. Such autoencoders and the generation of a reconstructed imaging dataset are discussed in the description of the first or second embodiment of the disclosure.

In this way, the quality of the anomaly detection image is improved. Instead of an autoencoder, principal component analysis can be used to generate the reconstructed dataset.

In an example of the third or fourth embodiment, the anomaly detection method is a method according to the first or second embodiment of the disclosure.

In an example of the third or fourth embodiment, the at least one calibration method is selected from a group of calibration methods. In an example, the steps of determining a calibrated anomaly detection image and applying a single threshold to the calibrated anomaly detection image are repeated iteratively for each calibration method of a group of calibration methods.

In an example of the third or fourth embodiment, the method further comprises the step of selecting one or more values of the domain of the distribution of the anomaly detection image values as thresholds by, for example, a user input. Thresholds can comprise minimum and maximum values of the domain of the distribution of the anomaly detection image values, e.g. minimum and maximum values of the intensity values of an anomaly or defect. By this method, multiple adapted thresholds can be applied in combination with filters.

For example, the anomaly detection image can be calibrated by applying the at least one calibration method comprising the following steps:
for each defect class of the subset of the defect classes, computing an intermediate calibrated anomaly detection image by adapting the anomaly detection image values based on the selected one or more thresholds of the anomaly detection image values of the current defect class;
applying one or more filters of the current defect class, e.g., a size filter; and finally
generating the calibrated anomaly detection image by applying an operator to all intermediate calibrated anomaly detection images.

Throughout this description the term “subset” of a set refers to a single, some or all elements of the set.

In an example of the third or fourth embodiment, the operator is selected from a group containing pixelwise sum, pixelwise average, pixelwise minimum, pixelwise maximum, pixelwise scaling. In this way, the final calibrated anomaly detection image contains defects from different defect classes each of which are extracted from the original anomaly detection image based on a different set of thresholds and filters. Using the maximum operator preserves as many of the anomalies as possible (provided anomalies are marked by a higher value than the background), whereas the minimum operator further reduces noise and nuisances.

According to a second example of the third or fourth embodiment, the method includes the step of providing annotated defects. The annotated defects are used to automatically set the desired thresholds to be applied to a calibrated anomaly detection image. According to the second example, only a small number of annotated defects for a few defect classes is involved, while other defect classes can be left unannotated. The method according to the example relies on the assumption that the annotated defects cover the appearance spectrum of all defect classes. Few defect classes means that the subset of the defect classes contains less than 50% of all defect classes, such as less than 30% of all defect classes, such as less than 20% of all defect classes, for example less than 10% of all defect classes. A small number of annotated defects for each class means more than 5 but less than 20 annotated defects, such as more than 5 but less than 10 annotated defects per defect class. With a method according to the second example, an annotation of defects are addressed and the thresholds for the calibrated anomaly detection image can be set automatically.

In the calibration method according to the second example, the task of automatically finding thresholds can be formulated as a pixelwise localization issue, e.g. a pixelwise segmentation issue. Many different designs of the pixelwise localization of the second embodiment are conceivable depending on various assumptions, e.g., on the type of annotations (bounding box, click-points, pixel-level or image-level annotations, multiple-user annotations, annotations derived from secondary sources etc.), loss functions (addressing model complexity through regularization, inclusion of prior knowledge, handling class imbalance etc.) or problem formulations (as semantic segmentation, object detection, classification, regression, handling out of distribution samples etc.).

In an example of the third or fourth embodiment, the machine learning model for anomaly localization is trained to optimize a loss function based on anomaly and non-anomaly samples. This allows for a highly accurate pixel-wise detection of anomalies, which is considerable in the semiconductor field. The samples from the distributions of anomaly detection image values for each defect class of a subset of the defect classes can be used as anomaly samples. In a further example, the loss function is a semi-supervised loss function. Based on a semi-supervised loss function, the quality of the anomaly detection can be improved, since expert annotations can be regarded during training of the calibration method. Yet, the user effort is still kept at a low level, since only a few annotations are involved and most of the samples are selected automatically. Throughout this description the term “foreground sample” is used as a synonym for “anomaly sample”, and the term “background sample” is used as a synonym for “non-anomaly sample”.

Specifically, the samples from the distributions of anomaly detection image values for each defect class of a subset of the defect classes can be used as anomaly samples while the non-anomaly samples can be selected (automatically) from the remaining pixels of the anomaly detection image. A remaining pixel of the anomaly detection image can be selected as non-anomaly sample, if its anomaly detection image value lies below a threshold. Additionally or alternatively, each non-anomaly sample can be weighted by a weighting function w of its anomaly detection image value aᵢ, in particular by the negative exponential weighting function w(αᵢ)=exp(−aᵢ). This allows for an automatic selection of a large amount of non-anomaly pixels at a minimum user effort. It also ensures the selection of non-anomaly pixels with high accuracy, since higher weights can be assigned to those pixels with the lowest likelihood of belonging to an anomaly, e.g., to pixels with a low anomaly detection image value, for example pixels with a very low autoencoder reconstruction error. Thus, if only a few samples are selected from the distributions of anomaly detection image values for each defect class of the subset of the defect classes, it is prevented that samples of these distributions which were not selected are mistakenly used as non-anomaly samples. In addition, the user effort can be reduced, since a low number of selected samples is sufficient to obtain anomaly detections of high accuracy.

A user provides only a small number of pixel-level annotations for a subset of the defect classes. The subset could contain all defect classes. Optionally, the subset does not contain all defect classes. Optionally, the subset may contains only a small number of defect classes, e.g. less than 10% of the defect classes. The annotation process is eased by utilizing available meta information (e.g., critical dimension, critical distance or pitch size). The user can provide a click-point which is processed into pixel level annotations, e.g. by dilating the click point to a circle of a size corresponding to the critical dimension, the critical distance or the pitch size representing lower or upper limits of the minimum structure sizes on the wafer. Alternatively, the user can use a brush to mark defect pixels. Based on these annotations a machine learning anomaly localization model, e.g. an anomaly segmentation or an anomaly detection model, can be trained. When applied to the anomaly detection image this localization model labels each pixel as anomaly-of-interest or nuisance. In this way, anomalies are highlighted while nuisance is reduced. Complementary postprocessing techniques can be employed to further reduce nuisance, e.g., histogram equalization, location-or-size based filtering etc. The calibrated anomaly detection image can finally be thresholded using a single threshold, e.g. 0.5, to obtain the defects in the imaging dataset.

According to an example of the third or fourth embodiment of the disclosure, during training, the machine learning model for anomaly localization is a machine learning model for anomaly segmentation. It considers partially annotated anomaly detection images such as difference images as input. As output, the model labels each pixel as anomaly-of-interest or nuisance. Since not all input pixels are annotated by the user, model learning is based on the following semi-supervised loss function:

$$L ( {y}_{true} , {y}_{pred} , a ) = - {\sum }_{i} l ( {y}_{true}^{i} , {y}_{pred}^{i} , {a}^{i} )$$

where α is the anomaly detection image, yₜᵤₑ is a user provided pixel level annotation from the set {unannotated=0, anomaly=1}, i.e. a partially labeled anomaly detection image, and y_{pred} is the label predicted by the model. The loss function L is the sum of losses over all pixels, which is a weighted cross entropy loss function, defined as:

$$l ( {y}_{true}^{i} , {y}_{pred}^{i} , {a}^{i} ) = - {w}^{i} ( {y}_{true}^{i} log {y}_{p r e d}^{i} + ( 1 - {y}_{true}^{i} ) log ( 1 - {y}_{p r e d}^{i} ) )$$

$${w}^{i} = {y}_{true}^{i} + ( 1 - {y}_{true}^{i} ) exp ( - {a}^{i} )$$

where pixel level weight wⁱ enables semi-supervised learning. Here, pixels annotated as anomaly (yⁱₜᵣᵤₑ=1) are learned to be segmented as anomaly. Unannotated pixels (yⁱₜᵣᵤₑ=0) are either considered as non-anomaly (in case of low aⁱ value) or ignored (in case of high aⁱ value), by the virtue of the negative exponential. As a result, the segmentation model suppresses noise and highlights anomalies, thereby improving the accuracy of the anomaly detections. The semi-supervised learning approach has the advantage that only a small number of user annotations is involved, while most of the training data is selected automatically based on the anomaly detection image values. In this way, user effort is limited and cold-starting made possible.

Alternatively, various other loss functions can be used for training the anomaly localization machine learning model, e.g., a Kullback-Leibler divergence loss function, an L1 or L2 loss function, etc.

An example of the third or fourth embodiment provides a method for the calibration of difference images, allowing to obtain high recall and manageable precision by applying a single threshold to a calibrated anomaly detection image. A machine learning model of the third or fourth embodiment is, therefore, comprising method steps to set up, to train and to apply a non-linear filter configured for amplifying defects while suppressing nuisance in difference images used for semiconductor defect detection.

In an example according to the third or fourth embodiment of the disclosure, a user interface is configured to let a user indicate the location of a small number of defects of each class of the subset of the defect classes in the anomaly detection image. To this end, the user interface is configured for a user indication of the location of a defect by selecting a single pixel, such as a pixel in the center region, of the defect and an annotation of the defect is automatically generated by selecting a region, such as a circle, surrounding the selected single pixel, and the anomaly detection image values are sampled from the region surrounding the selected pixel. The size of the region can be selected based on side information such as the critical dimension and/or the critical distance and/or the pitch size. The critical distance and the critical dimension are related to the minimum size of structures on the wafer, while the pitch size is related to the minimum distance between structures and, thus, can be understood as an upper limit for the minimum size of wafer structures. So the assumption can be made that anomalies are at least as large as the smallest structure on the wafer. Hence, the generated anomaly region surrounding the selected pixel can be automatically selected as the minimum size of wafer structures with respect to the critical dimension, critical distance or pitch size (converted to pixels). In this way, the accuracy of the anomaly detections is improved by automatically increasing the number of labeled samples. In addition, the limitation of the size of the anomaly region surrounding the selected pixel based on the size of the wafer structures prevents incorrect labels, especially for very small structures on wafers. Furthermore, the annotation effort for a user is greatly reduced since a single click is sufficient for annotating a defect. Thus, cold-starting becomes feasible, since very few selected samples are sufficient to train the machine learning model for anomaly localization despite the limited availability of training data at the beginning of the training.

The anomaly detection method according to the first or second embodiment and the anomaly detection method according to the third or fourth embodiment can be trained in many variations. They can be trained jointly as a single module, which is easier to maintain and evaluate. On the other hand, independent modules have the advantages of versatility and separation of expert opinion.

It should be noted that the computer implemented method for the detection of anomalies in an imaging dataset can comprise both the hyperparameter optimization according to any of the examples of the first or second embodiment as well as the calibration of the anomaly detection image according to any of the examples of the third or fourth embodiment simultaneously. All features according to the embodiments or examples can also be applied to this combined approach.

Anomaly detection can be a first step in a workflow for defect detection (and possibly classification). Especially, to obtain an approach suitable for cold-starting, anomaly detection is a valuable first step for scanning large amounts of data, so only samples possibly including defects are presented to a user for annotation.

Additionally, one or more properties of the detected anomalies can be measured, e.g. their size, location or shape parameters, or an anomaly density for a specific region or the whole imaging dataset. Based on such measurements at least one wafer manufacturing process parameter can be controlled based on the one or more measured properties, or the quality of the wafer can be assessed based on the one or more measured properties and at least one quality assessment rule.

Thus, the detected anomalies can be used for controlling the quality of wafers produced in a semiconductor manufacturing fab or for controlling the production process of wafers in a semiconductor manufacturing fab.

Furthermore, one or more machine-readable hardware storage devices can comprise instructions that are executable by one or more processing devices to perform operations comprising any of the methods disclosed herein.

An inspection system for controlling the quality of a wafer produced in a semiconductor manufacturing fab comprises the following features: an imaging device adapted to provide an imaging dataset of the wafer, an optional graphical user interface configured to present data to the user and obtain input data from the user, one or more processing devices, one or more machine-readable hardware storage devices comprising instructions that are executable by one or more processing devices to perform operations comprising one of the methods disclosed herein comprising assessing the quality of the wafer based on the one or more measurements and at least one quality assessment rule.

The system for controlling the production of wafers in a semiconductor manufacturing fab comprises the following features: a mechanism for producing wafers controlled by at least one manufacturing process parameter, an imaging device adapted to provide an imaging dataset of the wafer, an optional graphical user interface configured to present data to the user and obtain input data from the user, one or more processing devices, one or more machine-readable hardware storage devices comprising instructions that are executable by one or more processing devices to perform operations comprising a method comprising controlling at least one wafer manufacturing process parameter based on the one or more measurements.

According to the embodiments described herein, various imaging modalities may be used to acquire an imaging dataset for detection and classification of defects. Along with the various imaging modalities, it would be possible to obtain different imaging data sets. The imaging dataset could comprise one or more multisensory images. The imaging dataset can be a multibeam SEM image or a focused ion beam image, for example generated by a Helium ion microscope (HIM). The imaging dataset could comprise two-dimensional images, three-dimensional images, slice-wise three-dimensional images or multisensory-fusion images. For instance, it would be possible that the imaging dataset includes 2-D images. Here, it would be possible to employ a multibeam SEM. A multibeam SEM employs multiple beams to acquire contemporaneously images in multiple fields of view. For instance, a number of not less than 50 beams could be used or even not less than 90 beams. Each beam covers a separate portion of a surface of the wafer. Thereby, a large imaging dataset is acquired within a short duration of time. Typically, 4.5 gigapixels are acquired per second. For illustration, one square centimeter of a wafer can be imaged with 2 nm pixel size leading to 25 terapixel of data. Other examples for imaging data sets including 2D images would relate to imaging modalities such as optical imaging, phase-contrast imaging, x-ray imaging, etc. It would also be possible that the imaging dataset is a volumetric 3-D dataset, which can be processed slice-by-slice or as a three-dimensional volume. Here, a crossbeam imaging device including a focused-ion beam (FIB) source, an atomic force microscope (AFM) or a scanning electron microscope (SEM) could be used. Multimodal imaging datasets may be used, e.g., a combination of x-ray imaging and SEM. The imaging dataset 22 can, additionally or alternatively, comprise aerial images acquired by an aerial imaging system. An aerial image is the radiation intensity distribution at substrate level. It can be used to simulate the radiation intensity distribution generated by a photolithography mask 14 during the photolithography process. The aerial image measurement system can, for example, be equipped with a staring array sensor or a line-scanning sensor or a time-delayed integration (TDI) sensor.

While the examples and embodiments of the disclosure are described with respect to semiconductor wafers, it is understood the the disclosure is not limited to semiconductor wafers, but can for example also be applied to masks for semiconductor fabrication or in various other fields, e.g. for anomaly detection in manufactured components or biological samples.

The disclosure described by examples and embodiments is not limited to the embodiments and examples but can be implemented by those skilled in the art by various combinations or modifications thereof. In the following, exemplary embodiments of the disclosure are described and schematically shown in the figures.

### BRIEF DESCRIPTION OF THE DRAWINGS

FIG. 1 shows a schematic defective cell structure containing a plurality of anomalies due to various defects.

FIG. 2 shows a flow chart and results of an anomaly detection method such as an autoencoder applied to an imaging dataset of a wafer.

FIG. 3 shows a flow chart of an anomaly detection method according to the first or second embodiment of the disclosure.

FIG. 4 shows a result of an anomaly detection method obtained by a common hyperparameter optimization approach.

FIG. 5 shows a flowchart of the anomaly detection method according to an example of the first or second embodiment of the disclosure.

FIG. 6 shows a result of the anomaly detection method according to an example of the first or second embodiment of the disclosure based on an objective function comprising at least two different model evaluation metrics.

FIG. 7 illustrates the sampling strategy of the tree structured Parzen estimator;

FIG. 8 illustrates the pruning strategy of the asynchronous successive halvings algorithm.

FIG. 9 shows the evolution of the objective function value for different machine learning models defined by hyperparameters selected according to the sampling strategy of the tree structured Parzen estimator.

FIG. 10 shows a flow chart of the computer implemented method for the detection of anomalies in an imaging dataset of a wafer according to the third or fourth embodiment of the disclosure;

FIG. 11 shows a flow chart of the computer implemented method for the detection of anomalies in an imaging dataset of a wafer according to an example of the third or fourth embodiment of the disclosure.

FIG. 12 illustrates the steps of the computer implemented method for the detection of anomalies in an imaging dataset of a wafer according to the third or fourth embodiment of the disclosure.

FIG. 13 shows a comparison of an anomaly detection image and a calibrated anomaly detection image obtained by the computer implemented method for the detection of anomalies in an imaging dataset of a wafer according to the third or fourth embodiment of the disclosure.

FIG. 14 shows confusion matrices for an anomaly detection image and a calibrated anomaly detection image obtained by the computer implemented method for the detection of anomalies in an imaging dataset of a wafer according to the third or fourth embodiment of the disclosure.

FIG. 15 schematically illustrates a system for controlling the quality of wafers in a semiconductor manufacturing fab.

FIG. 16 schematically illustrates a system for controlling the production of wafers in a semiconductor manufacturing fab.

### EXEMPLARY EMBODIMENTS

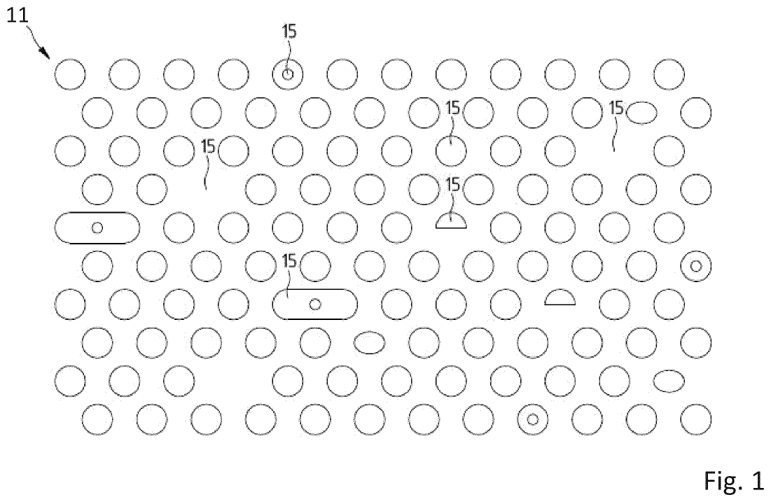

FIG. 1 shows a schematic defective cell structure 11 containing a plurality of anomalies 15. An anomaly 15 is a localized deviation of the imaging dataset 12 from an a priori defined norm, here the deviation from a normed semiconductor structure.

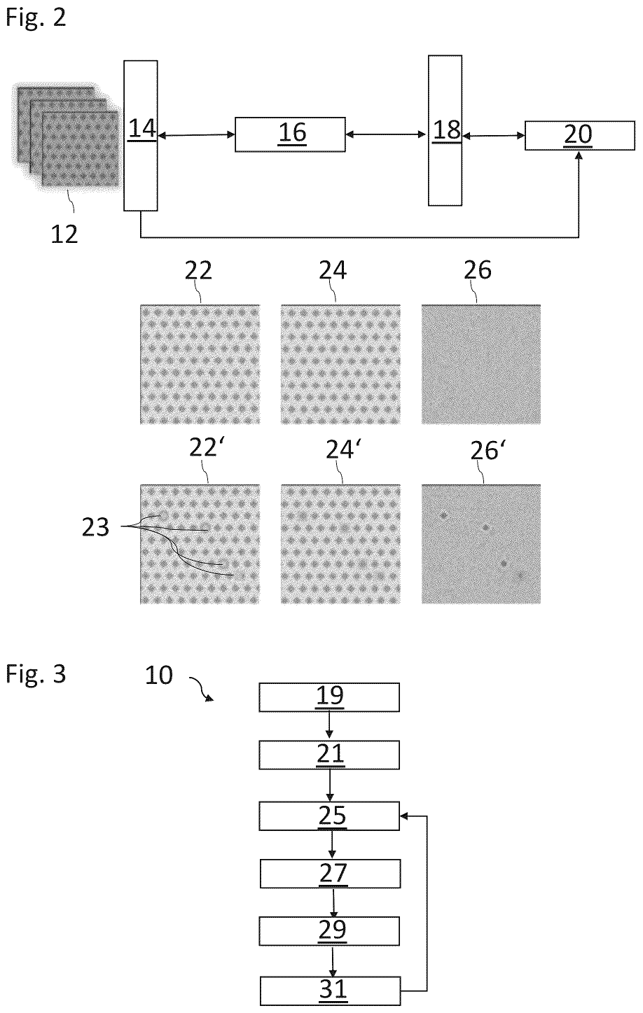

FIG. 2 shows a flow chart and results of an anomaly detection method such as an autoencoder applied to an imaging dataset 12 of a wafer 120. The input 14 of the method contains an imaging dataset 12 of a wafer 120 containing one or more images of the wafer 120. Based on the imaging dataset 12 a machine learning model 16 is trained. This machine learning model 16 can be based on a die-to-database principle or on a die-to-die principle. An autoencoder model is trained based on a die-to-die principle based on the imaging dataset 12. Autoencoders learn a compressed internal representation of the abundantly available “clean” or “defect free” data. As a result, the machine learning model 16 is capable of perfectly reconstructing defect-free image samples. During testing, contaminated input images are not faithfully reconstructed. Spatial regions with high reconstruction error indicate outliers with respect to training data also known as anomalies 15. Based on the autoencoder model a comparison dataset in the form of a reconstruction 18 of the input 14 is computed. The defects 23 in the imaging dataset 12 are not reconstructed by the autoencoder, so the difference between the reconstruction 18 (comparison dataset) and the input 14 contains the defects 23 in the imaging dataset 12. Since any imaging artefact such as noise, varying semiconductor structures or imperfect lithography etc. also causes a difference in the difference image, not all such differences are due to defects 23. Therefore, the defects 23 only form a subset of the anomalies 15. Anomalies 15 that are not defects 23 but detected by some anomaly detection method are referred to as nuisance. The difference image shows the anomalies 15 in the imaging dataset 12. Therefore, the difference image is an anomaly detection image 20.

Based on the input image 22 without defects a reconstruction image 24 is obtained, which differs only due to noise as shown by the difference image 26. The input image 22′ including defects 23 is reconstructed in the reconstruction image 24′ except for the regions containing the defects 23, which are only partially reconstructed. The difference image 26′, therefore, contains deviations from 0 at defect locations. The defects can be localized by applying a threshold to the difference image 26′.

An autoencoder is a machine learning model based on unsupervised learning and, thus, derives information only from the input data without any human input. However, expert knowledge is still used to supervise the model training by defining hyperparameter values for hyperparameters defining the machine learning model, e.g. the bottleneck size. To reduce a user interaction and to improve the reconstruction results of the autoencoder a computer implemented method 10 for the detection of anomalies 15 according to a first or second embodiment of the disclosure as shown in FIG. 3 comprises the following steps: selecting an imaging dataset 12 of a wafer 120 in a data selection step 19, generating training data from the imaging dataset 12 in a training data generation step 21 and iterating the following steps: in a hyperparameter value selection step 25, selecting a hyperparameter value from an associated set of hyperparameter values or a selecting a plurality of hyperparameters from a plurality of associated sets of hyperparameter values, based on a sampling strategy, the hyperparameter values corresponding to at least one hyperparameter that defines a machine learning model 16 for the detection of anomalies 15; in a training step 27, training the machine learning model 16 defined by the hyperparameter 48 based on a subset of the generated training data; in a model evaluation step 29, evaluating the trained machine learning model 16 by computing an associated objective function value of an objective function; and, in a model selection step 31, selecting one of the trained machine learning models based on the associated objective function value and applying it to the imaging dataset 12 of a wafer 120 to detect anomalies 15.

The objective function makes sure that a hyperparameter or a plurality of hyperparameters is selected such that the machine learning model defined by the hyperparameter or the plurality of hyperparameters reconstructs the imaging dataset 12 correctly except for the regions containing defects 23. To this end, the objective function can contain a model evaluation metric in the form of an Lp-norm loss function, p≥1, ensuring the correct reconstruction of the imaging dataset 12 without anomalies by penalizing deviations. For example, an L₂-norm loss function, which is the mean squared error loss function, is the default choice as objective function of most hyperparameter optimization methods.

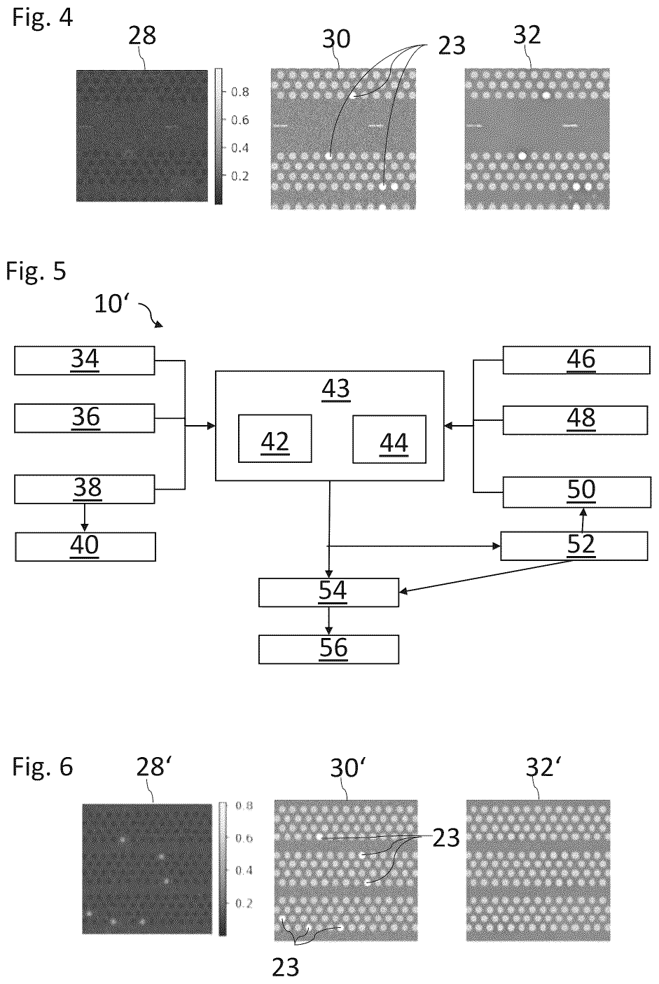

Yet, if the objective function for hyperparameter optimization only contains an Lp-norm based model evaluation metric the autoencoder will learn to also reconstruct any defects 23 contained in the imaging dataset 12. The defects 23 contained in the input image are, therefore, at least partially reconstructed, and the difference image only shows slight deviations from 0 at defect locations or none at all as shown in FIG. 4.

In FIG. 4 the result of an anomaly detection method obtained by a common hyperparameter optimization approach is shown. An input image 30 is reconstructed by an autoencoder machine learning method 16, which was obtained by a standard hyperparameter optimization method based on an objective function comprising only an Lₚ-norm metric. This yields a comparison dataset in the form of a reconstruction image 32 including all of the defects 23, so the anomaly detection image 28 in the form of a difference image does not show any of the defects 23 present in the imaging dataset 12 as anomalies 15.

FIG. 5 shows a flowchart of the anomaly detection method 10′ according to an example of the first or second embodiment of the disclosure. The method comprises a hyperparameter optimization unit 43, which carries out the training data generation step 21 to generate training data from the imaging dataset 12, the hyperparameter value selection step 25 to select hyperparameter values, the training step 27 to train the machine learning model 16 based on the selected hyperparameter values, the model evaluation step 29 to evaluate the trained machine learning model via the objective function 46 and the model selection step 31 to select one of the trained machine learning models 16 based on the associated objective function values.

The machine learning models for anomaly detection trained according to the first or second embodiment of the disclosure such as based on a die-to-die or die-to-database principle. In both cases abundant, such as defect-free data 34 is used for training the machine learning model 16, e.g. an autoencoder or a principal component analysis.

The hyperparameter optimization unit 43 involves an objective function 46, which is used to evaluate each of the trained machine learning models 16. The objective function 46 comprises one or multiple model evaluation metrics. In an example of the first or second embodiment of the disclosure, the objective function comprises at least two different model evaluation metrics 46 to prevent the trained machine learning model from reconstructing defects 23 and anomalies 15 as well.

Apart from the Lₚ-norm loss function a model evaluation metric is the discriminative loss function L_{CE}, which also involves a few expert annotations 36. The expert annotations 36 are given, e.g., as pixelwise annotations or as bounding boxes. These expert annotations 36 can be facilitated using expert knowledge 38, e.g. based on the critical distance, critical dimension or pitch size, which are related to the minimum size of structures on the wafer. In this way, it suffices for an expert to simply click in the center of a defect 23 in the anomaly detection image or the imaging dataset 12 and a larger region corresponding to the critical distance, critical dimension or pitch size is automatically assigned as defect 23 around the click point.

The hyperparameter optimization unit 43 comprises a sampler 42 and a pruner 44. The sampler 42 is used for carrying out the sampling strategy by selecting a hyperparameter value for a hyperparameter 48 from an associated set of hyperparameter values. In an example, expert knowledge 38 is applied by introducing hyperparameter ranges 40 for hyperparameters. From these ranges the hyperparameter values are selected by the sampler 42. Additionally or alternatively, expert knowledge 38 can be applied by introducing probability distributions indicating the likelihood for each hyperparameter value for being selected by the sampling strategy, e.g. based on imaging hardware settings or design knowledge such as critical distance, critical dimension and/or pitch size. Each hyperparameter value corresponds to at least one hyperparameter 48 that defines a machine learning model for the detection of anomalies 15. Hyperparameters 48 can, for example, refer to the architecture of the neural network underlying the machine learning model (e.g. the number and size of layers or size of the bottleneck of autoencoder) or to the learning rate. The optional pruner 44 decides whether the training of a machine learning model 16 should be continued by selecting another hyperparameter value according to the sampling strategy or if the training should be interrupted, e.g. via an early stopping criterion. In the case of an interruption, new hyperparameter values can be selected randomly, possibly with regard to given hyperparameter ranges and/or probability distributions over hyperparameter values. Then training starts again according to the sampling strategy.

The machine learning models 16 are trained on a subsampled dataset 50, which is sampled from the full imaging dataset 52. The size of the subsampled dataset 50 increases with the number of iterations carried out by the hyperparameter optimization unit 43. In this way, cold-starting on a small subsampled dataset 50 is feasible with little effort and within a short time for the user. In addition, online learning and optimization becomes possible, since new training data can be easily incorporated into the training process, e.g., training data comprising new types of defects. Thus, the training process becomes fast and easily adaptable. After selecting the trained machine learning model achieving the best objective function value, the optimized machine learning model 54 is finally trained on the full imaging dataset 52 to obtain the final machine learning model 56 for anomaly detection.

FIG. 6 shows a result of the anomaly detection method according to the first or second embodiment of the disclosure, wherein at least two different model evaluation metrics are combined in the objective function 46 to obtain improved results. In addition to the Lp-norm—for example an L₂ norm penalizing the deviation of the reconstruction images 32′ from the input images 30′—the objective function 46 comprises a discriminative loss function L_{CE} of defect/non-defect based on a few pixelwise annotations provided by an expert. The expert indicates locations of defects 23, which should not be reconstructed by the autoencoder. Therefore, the anomaly detection images 28′ (the difference images) can be compared to the binary labels indicated by a user by using a cross entropy loss as additional model evaluation metric in the objective function 46. The expert annotations 36 are not required to encompass all types of defects 23 occurring in the imaging dataset 12, and the number of annotations is very low, e.g. less than 10%, such as less than 1% of the training data samples. Since annotations can be provided via multiple formats (e.g., bounding box, click points, auxiliary process information etc.), the discrimination loss (L_{CE}) is adapted accordingly. E.g., bounding box annotations are associated with an overlap metric, i.e., intersection-over-union loss L_{IOU}.

In an example of the first or second embodiment of the disclosure, the objective function 46 also comprises a model evaluation metric comprising an Occam-razor penalty for complexity in order to avoid overfitting. This model evaluation metric can be defined based on the logarithm of the total number of floating-point operations (L_{FLOP}) in one forward-pass of the model. Alternatively, the number and/or size of the layers of a trained neural network and/or the number of connections between the neurons and or other suitable hyperparameter values can be used as model evaluation metric for measuring the complexity of the machine learning model. This complexity based model evaluation metric is optional.

In an example of the first or second embodiment of the disclosure, the objective function, thus, comprises a weighted sum of three model evaluation metrics, e.g.,

$$f = {w}_{1} {L}_{2} + {w}_{2} {L}_{CE} + {w}_{3} {L}_{FLOP}$$

where the weights w₁, w₂, w₃ are chosen by the expert. Typically, the first two weights are of similar magnitude whereas the third is at least ten times lower, e.g., w₁=10, w₂=1, w₃=0.01. One or several of the weights, e.g. the weight w₃, can be set to 0. Instead of the L₂-norm any other Lₚ-norm can be used. The discriminative loss function L_{CE} can be replaced by any loss function penalizing the deviation of the difference image and some groundtruth data for anomalies in the imaging dataset, e.g. an intersection over union loss L_{IOU}. In an example, the objective function also or alternatively comprises a quality value as model evaluation metric to evaluate the quality of the trained machine learning model 16, wherein a user interface 128 is configured to present information on the trained machine learning model 16 to a user and let the user indicate the quality value. Additional model evaluation metrics can be added or used instead of one or more of the model evaluation metrics described above. In addition, all options of the backbone Optuna library can be added.

FIG. 6 shows the same input image 30′ including defects 23 as in FIG. 4. In the reconstruction image 32′ the defects 23 are not reconstructed since the objective function comprises at least two model evaluation metrics. While correctly reconstructing the background image, the reconstruction does not replicate any of the defects 23 (white circles) as desired. Consequently, the difference image as anomaly detection image 28′ contains the defects 23.

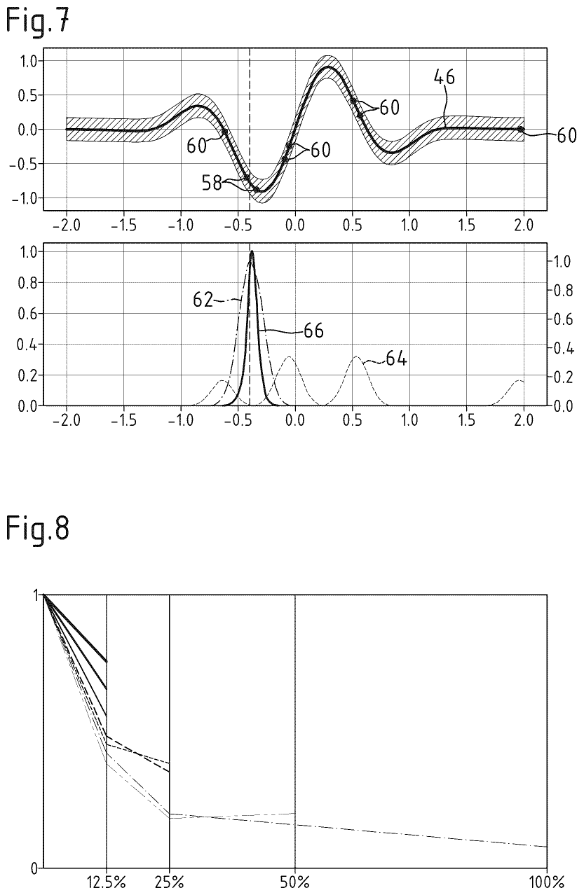

FIG. 7 illustrates the sampling strategy of the tree structured Parzen estimator (TPE), which can be used for sampling hyperparameter values by the sampler 42.

A Parzen density estimator is a non-parametric kernel density estimator used to estimate the probability density function of a random variable (the hyperparameter values) given a set of observations x=x₁, . . . ,xn:

$${f}_{h} ( x ) = \frac{1}{n} {\sum }_{i = 1}^{n} {K}_{h} ( x - {x}_{i} ) ,$$

where Kₕ is a kernel with bandwidth h.

The idea of Parzen estimators is close to Bayesian optimization while standing on an opposite theoretical ground. While Bayesian optimization tries to figure out p(y|x) (y is the value of the objective function and x is the hyperparameter value), a tree of Parzen estimators models p(x|y) and p(y).

As for Bayesian optimization, the first step in TPE is to start sampling the objective function 46 by random search to initialize the algorithm.

Then the observations are split in two groups: the best performing one according to the objective function 46 (the good group 58, e.g. the upper quartile) and the remaining ones (the bad group 60) defining y* as the splitting value for the two groups.

The probability for being in each of these groups is modeled (Gaussian processes model the posterior probability), as p(x|y)=l(x) if y<y* and p(x|y)=g(x) if y≥y*.

The two densities l and g are modeled using Parzen density estimators. Here g denotes the density of the good group 62 and l the density of the bad group 64.

p(y) is modeled using the fact that p(y<y*)=δ which defines the percentile split in the two categories (i.e. δ=0.75 if g models the upper quartile).

Using Baye's rule (i.e. p(x,y)=p(y) p(x|y)), it can be shown that the definition of expected improvement (EI) 66 is equivalent to l(x)/g(x).

The next point is then selected as the maximizer of l(x)/g(x) by this sampling strategy, as shown in FIG. 7.

FIG. 8 illustrates the pruning strategy of the asynchronous successive halvings algorithm, which is used by the pruner 44 in an example of the first or second embodiment of the disclosure to decide if training of a model is continued or stopped. On the vertical axis the training loss function is shown and on the horizontal axis the training time. The lower the objective function value the better performs the model defined by the associated one or more hyperparameter values. Only the hyperparameter value or values achieving the lowest objective function value are continuously improved, while the remaining sets are abandoned in an early iteration.

### Asynchronous Successive Halving Algorithm (ASHA)

The ASHA algorithm as shown in FIG. 8 is a pruning strategy and a way to combine random search with principled early stopping in an asynchronous way.

The successive halving algorithm (SHA) is a well-known multi-armed bandit algorithm to perform principled early stopping. The successive halving algorithm begins with all candidate configurations in the base rung and proceeds as follows:
1. Uniformly allocate a budget (value on horizontal axis) to a set of candidate hyperparameter configurations in a given rung;
2. Evaluate the performance of all candidate configurations;
3. Promote the top 1/f of candidate configurations to the next rung, where f is an elimination rate selected by a user;
4. Double the budget per configuration for the next rung and repeat until one configuration remains.

Higher η indicates a more aggressive rate of elimination where all but the top 1/η of configurations are eliminated.

The SHA algorithm is difficult to parallelize because the algorithm takes a set of configurations as input and waits for all configurations in a rung to complete before promoting configurations to the next rung.

To remove the bottleneck created by synchronous promotions, the asynchronous successive halving algorithm (ASHA) grows from the bottom up and promotes configurations whenever possible instead of starting with a wide set of configurations and narrowing down.

ASHA begins by assigning workers to add configurations to the bottom rung. When a worker finishes a job and requests a new one, the rungs from top to bottom are examined to see if there are configurations in the top 1/η of each rung that can be promoted to the next rung. If not, the worker is assigned to add a configuration to the lowest rung to grow the width of the level so that more configurations can be promoted.

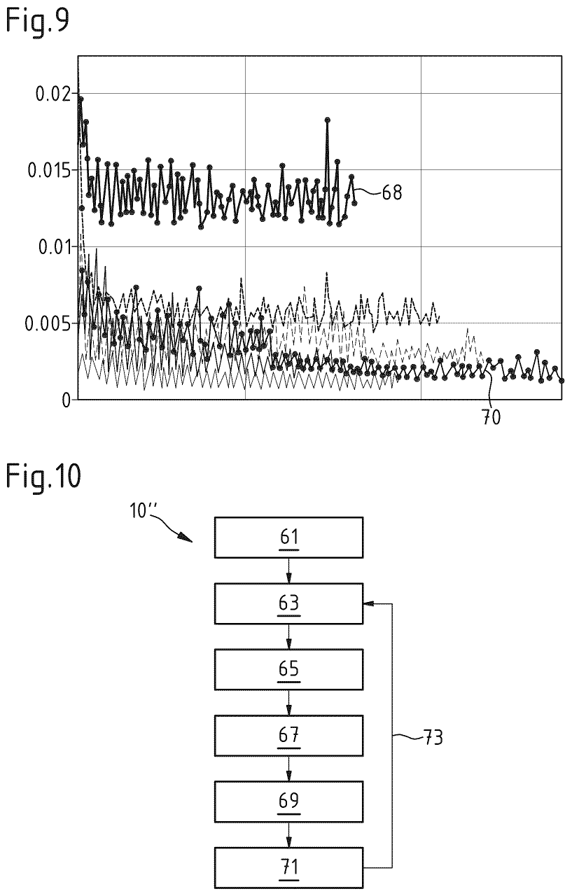

The output of the ASHA algorithm is shown in FIG. 9 summarizing the outcomes of all trials. Here, 17 trials were carried out for hyperparameter optimization. Of the initial trials, the worst trial 68 achieving the worst objective function value was dropped in the first iteration. In each subsequent iteration, the best models from the previous iteration were seeded and trained longer. Finally, the best trial 70 was re-trained on the original full training dataset.

FIG. 10 shows a flowchart of the computer implemented method 10″ for anomaly detection in an imaging dataset 12 of a wafer 120, the imaging dataset 12 comprising defects 23 belonging to a number of defect classes, according to the third or fourth embodiment of the disclosure, the method comprising the following steps: in an anomaly detection image generation step 61, generating an anomaly detection image 72 by applying an anomaly detection method to an imaging dataset 12; performing one or more iterations 73, at least one of them comprising the following steps: in a sampling step 63, providing one or more samples of a distribution of anomaly detection image values for each defect class of a subset of the defect classes; in a calibration step 65, calibrating the anomaly detection image 72 via at least one calibration method comprising the following steps: in a training step 67, training a machine learning model for anomaly localization, such as anomaly segmentation, based on the one or more samples of the distribution of the anomaly detection image values; in an application step 69, applying the trained machine learning model to the anomaly detection image 72 to obtain the calibrated anomaly detection image; in a thresholding step 71, applying a threshold to the calibrated anomaly detection image to detect anomalies 15, thereby reducing nuisance and highlighting defects 23 in the anomaly detection image 72.

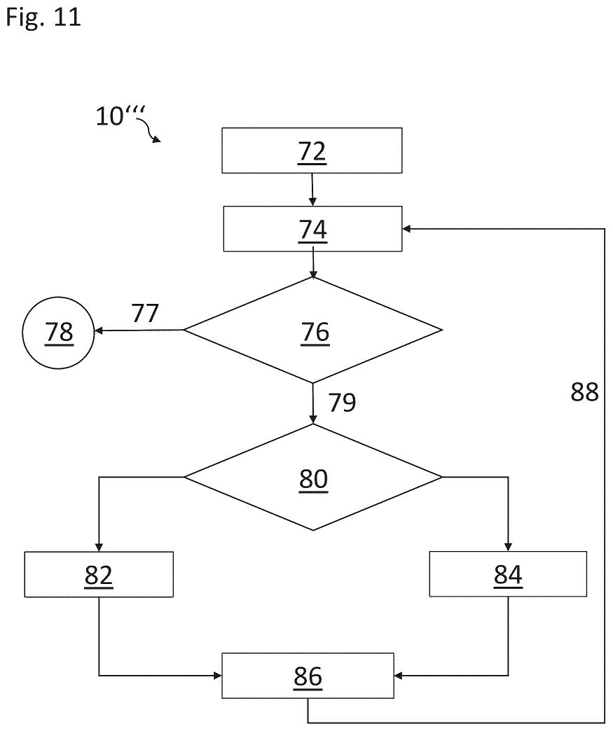

FIG. 11 shows a computer implemented method 10″′ for anomaly detection in an imaging dataset 12 of a wafer 120 according to an example of the third or fourth embodiment of the disclosure. The anomaly detection image 72 is calibrated in a calibration step 74 in each iteration 88. In the calibration step 74, a calibration method is selected from a set of calibration methods.

The set of calibration methods comprises a first calibration method for training a machine learning model for anomaly localization based on the one or more samples of the distributions of the anomaly detection image values for all defect classes of the subset of the defect classes. The trained machine learning model is then applied to the anomaly detection image 72. Finally, a threshold is applied to the calibrated anomaly detection image to obtain the anomalies 15 or defects 23.

The set of calibration methods also comprises a second calibration method based on global or local thresholding and/or filter operations. To this end, one or more lower and/or upper thresholds are selected for an anomaly detection image 72 and the anomaly detection image 72 is adapted based on these thresholds. The filter operations can comprise, e.g., morphological cleaning, cluster size filtering, size filtering, etc. Size filters, for example, indicate the minimum and maximum size of the respective defect type, so only anomalies or defects exhibiting sizes within the indicated size range are detected. The size of an anomaly or defect can be measured by the number of connected pixels, the length of the anomaly or defect in a specific direction or its diameter, etc. The thresholding and the filter operations can be combined in the calibration method. A user interface can be configured to allow the user to select thresholds and/or filters. Finally, a threshold is applied to the calibrated anomaly detection image to obtain the anomalies 15 or defects 23.

In an evaluation step 76 it is checked whether all (or sufficiently many) defects 23 were detected. In case of a positive answer 77 the iterations 88 are terminated in a termination step 78. Otherwise in case of a negative answer 79, the calibration methods are adapted in a calibration method adaptation step 80.

To adapt the first calibration method, annotations are added or adapted in an annotation adjustment step 84 by expert annotations, e.g. by clicking on a defect and applying expert knowledge such as critical dimension and/or critical distance and/or pitch size related to a minimum structure size. To adapt the second calibration method, thresholds and/or filters are added or adapted in a threshold or filter adjustment step 82, e.g. by user input. The calibration method can be adapted based on the additional information, e.g., the machine learning model for anomaly localization is retrained in a training step 86. In each iteration 88 a different calibration method can be selected and applied to the calibrated anomaly detection image from the previous iteration.

In an example of the example of the third or fourth embodiment of the disclosure, the second calibration method comprises the following steps: for each defect class of the subset of the defect classes, computing an intermediate calibrated anomaly detection image by adapting the anomaly detection image values based on the selected one or more thresholds of the anomaly detection image values of the current defect class; applying one or more filters of the current defect class, e.g., a size filter, so only anomalies 15 within a certain size range are preserved by the calibration method; and finally generating the calibrated anomaly detection image by applying an operator to all intermediate calibrated anomaly detection images, the operator being selected from the group containing pixelwise sum, pixelwise average, pixelwise minimum, pixelwise maximum, pixelwise scaling. In this way, the final calibrated anomaly detection image contains defects 23 from different defect classes each of which was extracted from the anomaly detection image 72 based on a different set of thresholds and filters. Using the maximum operator preserves as many of the anomalies 15 as possible, whereas the minimum operator further reduces noise and nuisances.

The adaptation of the anomaly detection image values α according to a first calibration method can relate to a normalization of the values based on an upper threshold u and a lower threshold l, i.e.

$${a}_{n e w} = min ( max ( \frac{a - l}{u - l} , 0 ) , 1 ) .$$

Alternatively, the adaptation of the anomaly detection image values can relate to a clipping of the values to a range [l,u]

α_{new}=min(max(α,l),u).

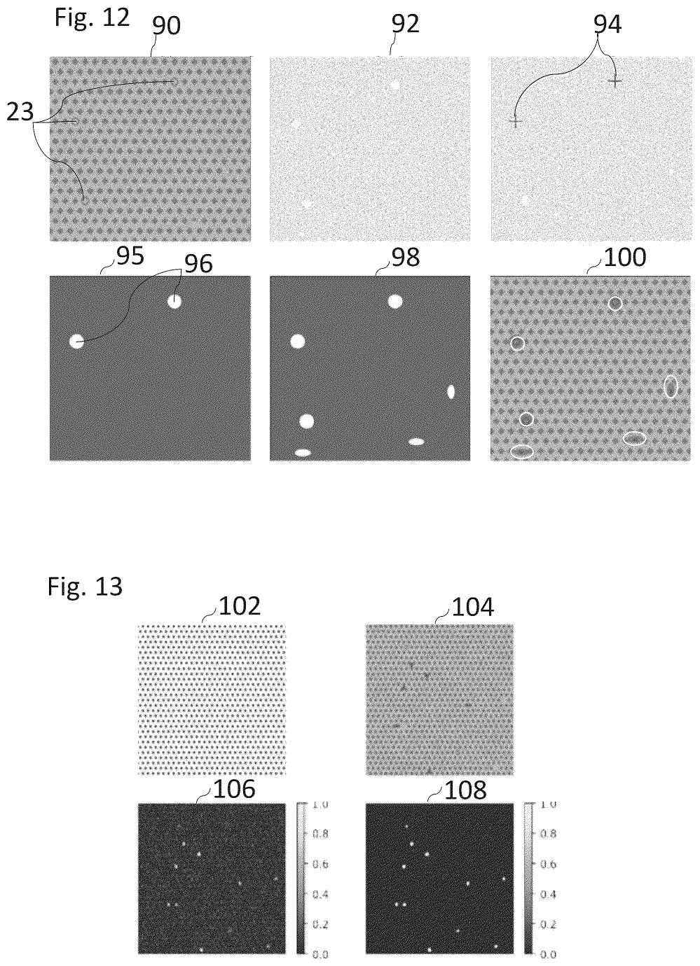

In an example according to the third or fourth embodiment of the disclosure, the calibration method is formulated as a pixelwise segmentation issue as illustrated in FIG. 12. The input image 90 to the anomaly detection method contains two classes of defects 23 called hollow diamonds and triangles. The output of the anomaly detection method is the anomaly detection image 92, which is the difference image between the input image 90 and a comparison dataset, here the output of an autoencoder reconstructing the input image 90. The speckled background is due to noise and a high reconstruction error around defects 23. A simple threshold ensuring high defect recall would yield a high nuisance rate. Therefore, the anomaly detection image 92 is calibrated using a machine learning model for anomaly localization. To this end, a user interface is configured to let the user provide expert annotations 96 on a few samples of a subset of the defect classes. To ease the annotation process, the user provides click-points 94 which are automatically processed into pixel level annotations 96 by utilizing available meta information (e.g., critical distance and/or critical dimension and/or pitch size). Based on this meta information, the click-points are dilated to regions covering the minimum structure size of the wafer. In the partially annotated anomaly detection image 95 annotated pixels are set to one, unannotated pixels to zero. It is sufficient if the user provides only a small number (about 5-10, less than 20) click-points for a subset of the defect classes. Even though the remaining defects 23 are not part of the training data they can still be segmented by the machine learning model for anomaly segmentation due to the assumption that the annotated classes cover the appearance spectrum of all defect classes. Based on the annotations the machine learning model for anomaly segmentation is trained. In this way, user effort is minimized and cold-starting made possible, because new defects 23 can also be detected based on limited training data and because the annotation process involves minimal user effort.

According to an example of the third or fourth embodiment of the disclosure, during training, the machine learning model for anomaly segmentation considers partially annotated anomaly detection images such as difference images as input. As output, the model labels each pixel as anomaly-of-interest or nuisance. Since not all input pixels are annotated by the user, model learning is based on the following semi-supervised loss function:

$$L ( {y}_{true} , {y}_{pred} , a ) = - {\sum }_{i} l ( {y}_{true}^{i} , {y}_{pred}^{i} , {a}^{i} )$$

where α is the anomaly detection image 92, yₜᵣᵤₑ is a user provided pixel level annotation from the set {unannotated=0, anomaly=1}, i.e. a partially labeled anomaly detection image 95, and y_{pred} is the label predicted by the model. The loss function L is the sum of losses over all pixels, which is a weighted cross entropy loss, defined as:

$$l ( {y}_{true}^{i} , {y}_{pred}^{i} , {a}^{i} ) = - {w}^{i} ( {y}_{true}^{i} log {y}_{p r e d}^{i} + ( 1 - {y}_{true}^{i} ) log ( 1 - {y}_{p r e d}^{i} ) )$$

$${w}^{i} = {y}_{true}^{i} + ( 1 - {y}_{true}^{i} ) exp ( - {a}^{i} )$$

where pixel level weight wⁱ enables semi-supervised learning. Here, pixels annotated as anomaly (yⁱₜᵣᵤₑ=1) are learned to be segmented as anomaly. Unannotated pixels (yⁱₜᵣᵤₑ=0) are either considered as non-anomaly (in case of low aⁱ value) or ignored (in case of high aⁱ value), by the virtue of the negative exponential. As a result, the segmentation model suppresses noise and highlights anomalies 15 as shown by the segmentation result, which corresponds to the calibrated anomaly detection image 98. Despite limited annotations and varying appearance both defect classes are segmented due to the semi-supervised loss function. The calibrated anomaly detection image 98 is overlaid on the input image 90, i.e. the imaging dataset 12 of the wafer 120, yielding the overlay 100.

FIG. 13 shows a qualitative analysis of the method according to the third or fourth embodiment of the disclosure. In the top row the reconstruction image 102 differs from the input image 104 in regions corresponding to defects 23. In the bottom row, the uncalibrated anomaly detection image 106 before applying the calibration method is shown. This uncalibrated image 106 exhibits high recall (all defects 23 are highlighted) but low precision (numerous specular highlights corresponding to noise), i.e., has numerous false positives. Furthermore, the intensity of highlights for each defect class is different. In the right column, the calibrated anomaly detection image 108 after applying the calibration method is shown. The calibrated anomaly detection image 108, shows both high recall and precision, with all defect classes showing a uniform intensity of 1.0. These can be detected easily and automatically based on a single uniform threshold of 0.5. The application of the calibration method, thus, retains high recall, significantly improves precision and ensures uniform intensity values for defects 23, so applying a single threshold to the calibrated anomaly detection image 108 is sufficient for anomaly detection.

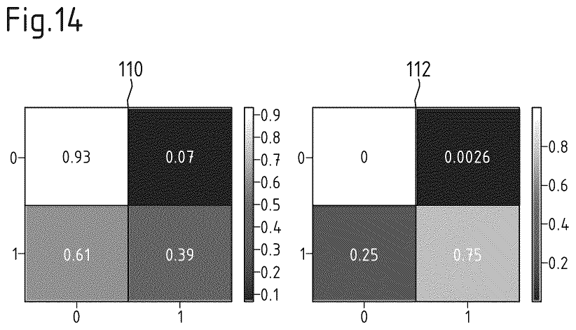

The benefit of applying the calibration method according to the third or fourth embodiment of the disclosure is quantified in FIG. 14, which shows the confusion matrix before calibration 110 and the confusion matrix after calibration 112, i.e., before and after segmenting the anomaly detection image 108 and applying a threshold at 0.5. In this way, a high recall rate is maintained (0.93 vs. 1.0) and a significant reduction in false positives achieved (from 0.61 to 0.25), which in turn boosts precision significantly.

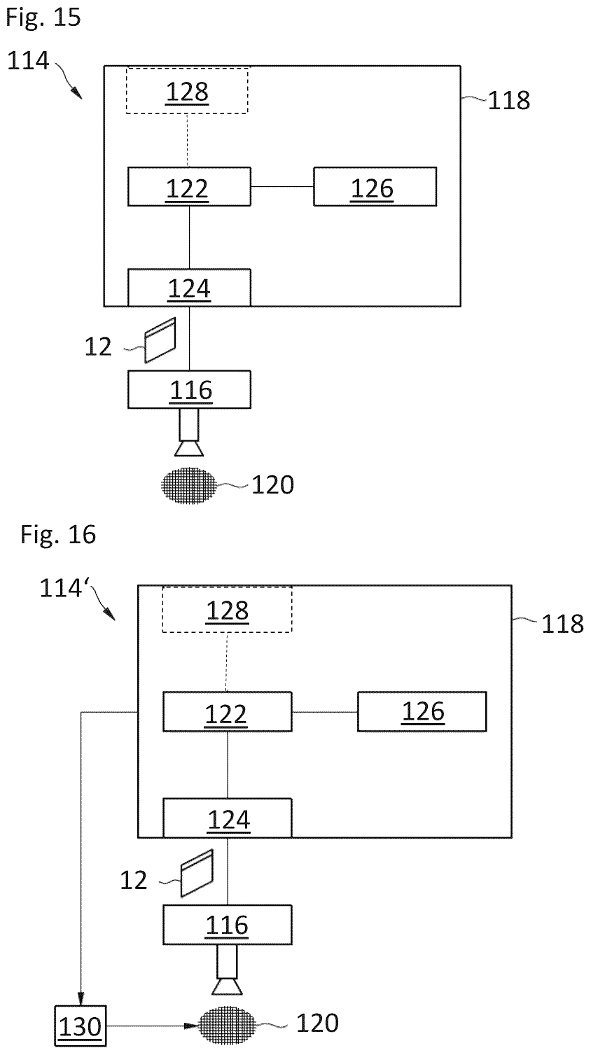

FIG. 15 schematically illustrates a system 114, which can be used for controlling the quality of wafers 120 produced in a semiconductor manufacturing fab. The system 114 includes an imaging device 116 and a processing device 118. The imaging device 116 is coupled to the processing device 118. The imaging device 116 is configured to acquire imaging datasets 12 of the wafer 120. The wafer 120 can include semiconductor structures, e.g., transistors such as field effect transistors, memory cells, et cetera. An example implementation of the imaging device 116 would be a SEM or multibeam SEM, a Helium ion microscope (HIM) or a cross-beam device including FIB and SEM or any charged particle imaging device.

The imaging device 116 can provide an imaging dataset 12 to the processing device 118. The processing device 118 includes a processor, e.g., implemented as a CPU 122 or GPU. The processor can receive the imaging dataset 12 via an interface 124. The processor can load program code from a memory 126. The processor can execute the program code. Upon executing the program code, the processor performs techniques such as described herein, e.g., hyperparameter optimization, training an anomaly detection method, executing an anomaly detection method to detect one or more anomalies 15 in an imaging dataset 12 of a wafer 120, calibrating anomaly detection images based on samples of anomaly detection image value distributions etc. For example, the processor can perform the computer implemented method shown in FIG. 3, FIG. 6 or FIG. 10 respectively upon loading program code from the memory 126. The processing device can optionally contain a user interface 128 for entering user input such as click-points, bounding-boxes or characteristics of distributions of anomaly detection image values.

FIG. 16 schematically illustrates a system 114′, which can be used for controlling the production of wafers 120 in a semiconductor manufacturing fab. The system 114′ comprises the same components as indicated in FIG. 14 and the above the also applies for the respective components here. In addition, the system 114′ has a mechanism 130 for producing wafers 120 controlled by at least one wafer manufacturing process parameter. To this end, an imaging dataset 12 is provided to the processing device 118 via the imaging device 116. The processor of the processing device 118 is configured to perform one of the disclosed methods comprising controlling the at least one wafer manufacturing process parameter based on one or more measured properties of the detected anomalies 15 in the imaging dataset 12 of the wafer 120. For example, detected anomalies 15 due to bridge defects indicate insufficient etching, so the amount of etching is increased, detected anomalies 15 due to line breaks indicate excessive etching, so the amount of etching is decreased, consistently occurring anomalies 15 indicate a defective mask, so the mask is checked, and anomalies 15 due to missing structures hint at non-ideal material deposition, so the material deposition is modified.

The following clauses contain embodiments of the disclosure:

1a. Computer implemented method for the detection of anomalies comprising:
Selecting an imaging dataset of a wafer;
Generating training data from the imaging dataset;
Iterating the following steps:
   i. Selecting a hyperparameter value from an associated set of hyperparameter values, based on a sampling strategy, the hyperparameter value corresponding to at least one hyperparameter that defines a machine learning model for the detection of anomalies;
   ii. Training the machine learning model defined by the hyperparameter based on a subset of the generated training data;
   iii. Evaluating the trained machine learning model by computing an associated objective function value of an objective function;
Selecting one of the trained machine learning models based on the associated objective function value and applying it to the imaging dataset of a wafer to detect anomalies.

1b. Computer implemented method for the detection of anomalies in an imaging dataset of a wafer, the imaging dataset comprising defects belonging to a number of defect classes, comprising:
Generating training data from the imaging dataset;
Iterating the following steps:
   i. Selecting a number of hyperparameter values, each from an associated set of hyperparameter values, based on a sampling strategy, each hyperparameter value corresponding to at least one hyperparameter that defines a machine learning model for the detection of anomalies;
   ii. Training the machine learning model for the detection of anomalies based on a subset of the generated training data;
   iii. Evaluating the trained machine learning model via an objective function comprising at least two different model evaluation metrics;
Selecting one of the trained machine learning models based on the associated objective function value and applying it to the imaging dataset of the wafer to detect anomalies thereby providing an anomaly detection image;
Performing one or more iterations, at least one of them comprising the following steps
   i. Providing one or more samples of the distribution of anomaly detection image values for each defect class of a subset of the defect classes;
   ii. Calibrating the anomaly detection image based on the samples of the distributions via a calibration method selected from a group of calibration methods, thereby reducing nuisance and highlighting defects in the anomaly detection image, wherein at least one of the selected calibration methods comprises the following steps:
      c. Training a machine learning model for anomaly localization, optionally anomaly segmentation, based on the one or more samples of the distributions of the anomaly detection image values for all defect classes of the subset of the defect classes;
      d. Applying the trained machine learning model to the anomaly detection image to obtain the calibrated anomaly detection image;
Applying a single threshold to the calibrated anomaly detection image to detect anomalies.

1c. Computer implemented method for the detection of anomalies in an imaging dataset of a wafer, the imaging dataset comprising defects belonging to a number of defect classes, the method comprising:
Providing an anomaly detection image generated by applying an anomaly detection model to the imaging dataset;
Performing one or more iterations, at least one of them comprising the following steps
   i. Providing one or more samples of the distribution of anomaly detection image values for each defect class of a subset of the defect classes;
   ii. Calibrating the anomaly detection image based on the samples of the distributions via a calibration method selected from a group of calibration methods, thereby reducing nuisance and highlighting defects in the anomaly detection images, wherein at least one of the selected calibration methods comprises the following steps:
      a. Training a machine learning model for anomaly localization, optionally anomaly segmentation, based on the one or more samples of the distributions of the anomaly detection image values for all defect classes of the subset of the defect classes;
      b. Applying the trained machine learning model to the anomaly detection image to obtain the calibrated anomaly detection image;
Applying a single threshold to the calibrated anomaly detection image to detect anomalies.

1. Computer implemented method for the detection of anomalies in an imaging dataset of a wafer comprising:
Generating training data from the imaging dataset;
Iterating the following steps:
   i. Selecting a number of hyperparameter values, each from an associated set of hyperparameter values, based on a sampling strategy, each hyperparameter value corresponding to at least one hyperparameter that defines a machine learning model for the detection of anomalies;
   ii. Training the machine learning model for the detection of anomalies based on a subset of the generated training data;
   iii. Evaluating the trained machine learning model via an objective function comprising at least two different model evaluation metrics;
Selecting one of the trained machine learning models based on the associated objective function value and applying it to the imaging dataset of the wafer to detect anomalies.

2. The method of any one of the preceding clauses, wherein the machine learning model when presented with a subset of the imaging dataset as input is trained to compute a reconstruction of the subset without anomalies, and the anomalies within the subset are detected based on a comparison between the subset and the reconstructed subset.

3. The method of clause 2, wherein the machine learning model comprises an autoencoder.

4. The method of any one of the preceding clauses, at least one hyperparameter is related to the design of the machine learning model.

5. The method of any one of the preceding clauses, wherein one of the model evaluation metrics comprises the loss function used during training of the machine learning model.

6. The method of any one of the preceding clauses, wherein one of the model evaluation metrics comprises an Lp-norm loss function, p≥1.

7. The method of any one of the preceding clauses, wherein the training data comprises expert annotations of anomalies for subsets of the imaging dataset, and one of the model evaluation metrics comprises a discriminative loss function evaluating the difference between the expert annotated anomalies and the detected anomalies.

8. The method of clause 7, wherein the expert annotations make up less than 10%, such as less than 1%, of the training data.

9. The method of clause 7 or 8, wherein the expert annotations contain only a subset of the anomalies present in the imaging dataset.

10. The method of any one of the preceding clauses, wherein one of the model evaluation metrics comprises a measure of the complexity of the machine learning model.

11. The method of clause 10, wherein the measure of the complexity of the machine learning model comprises the total number of floating-point operations in one forward-pass of the machine learning model.

12. The method of any one of the preceding clauses, wherein the objective function comprises a weighted sum of the at least two model evaluation metrics.

13. The method of clause 12, wherein the training data comprises expert annotations of anomalies for subsets of the imaging dataset, and the objective function comprises a weighted sum of an Lp-norm loss function, p≥1, a discriminative loss function evaluating the difference between the expert annotated anomalies and the detected anomalies and a measure of the complexity of the machine learning model.

14. The method of any one of the preceding clauses, wherein the sampling strategy for selecting the number of hyperparameter values comprises taking into account hyperparameter values and corresponding values of the objective function from one or more previous iterations.

15. The method of clause 14, wherein the sampling strategy selects hyperparameter values by optimizing one criterion selected from the group comprising expected improvement, maximum probability of improvement, upper confidence bound.

16. The method of any one of the preceding clauses, wherein the sampling strategy comprises an early stopping criterion.

17. The method of any one of the preceding clauses, wherein the sampling strategy comprises randomly selecting hyperparameter values from the associated set of hyperparameter values.

18. The method of any one of the preceding clauses, wherein at least one set of hyperparameter values is associated with a probability distribution indicating the likelihood for each hyperparameter value for being selected by the sampling strategy.

18a. The method of the preceding clause, wherein the probability distribution is modeled based on prior application based knowledge, such as based on imaging hardware settings or design knowledge such as critical distance.

19. The method of any one of the preceding clauses, wherein the sampling strategy differs for at least two iterations.

20. The method of any one of the preceding clauses, wherein the size of the subset of the generated training data varies based on the sampling strategy.

21. The method of clause 20, wherein the size of the subset of the generated training data increases with the number of iterations.

22. The method of any one of the preceding clauses, wherein prior knowledge based on the specific application is used to select initial hyperparameter values.

23. The method of any one of the preceding clauses, wherein the sampling strategy comprises
In the first iteration: selecting initial hyperparameter values from the associated set of hyperparameter values;
In the following iterations: selecting hyperparameter values from the associated set of hyperparameter values maximizing the criterion of expected improvement based on hyperparameter values and corresponding values of the objective function from one or more previous iterations;
If an early stopping criterion is met in an iteration: selecting initial hyperparameter values from the associated set of hyperparameter values.

24. The method of any one of the preceding clauses, wherein iterations are executed in parallel by several threads.

25. The method of any one of the preceding clauses, wherein the selected machine learning model is trained on the whole imaging dataset of the wafer before applying it to the imaging dataset of the wafer to detect anomalies.

26. The method of any one of the preceding clauses, wherein the trained machine learning model achieving the lowest objective function value is selected.

27. The method of any one of the preceding clauses, wherein the trained machine learning model achieving the highest objective function value is selected.

28. The method of any one of the preceding clauses, wherein the sampling strategy criterion implements at least one member selected from the group consisting of an explorative scheme and an exploitative scheme.

28a. The method of any one of the preceding clauses, wherein the objective function comprises a quality value to evaluate the quality of the trained machine learning model, wherein a user interface is configured to present information on the trained machine learning model to a user and let the user indicate the quality value.

29. Computer implemented method for the detection of anomalies in an imaging dataset of a wafer, the imaging dataset comprising defects belonging to a number of defect classes, the method comprising:
providing an anomaly detection image generated by applying an anomaly detection model to the imaging dataset;
performing one or more iterations of the following steps
   i. providing one or more characteristics of the distribution of anomaly detection image values for each defect class of a subset of the defect classes;
   ii. calibrating the anomaly detection image based on the characteristics of the distributions via a calibration method selected from a set of calibration methods, thereby reducing nuisance and highlighting defects in the anomaly detection image.

30. The method of clause 29, 1a, 1b or 1c, wherein the anomaly detection image is a difference image of the imaging dataset and a comparison dataset.

31. The method of clause 30, wherein the comparison dataset is based on a die-to-die principle or on a die-to-database principle.

32. The method of clause 30 or 31, wherein the comparison dataset is generated by a machine learning model.

33. The method of clause 32, wherein the comparison dataset comprises a reconstructed representation of the imaging dataset generated by training an autoencoder on the imaging dataset or a subset thereof and applying the trained autoencoder to the imaging dataset to obtain the reconstructed representation.

34. The method of clause 29, 1a, 1b or 1c, wherein the anomaly detection image is generated by a machine learning model.

35. The method of clause 34, wherein the anomaly detection and the calibration of the anomaly detection image are learned jointly by a machine learning model, which is applied to the imaging dataset to directly obtain the calibrated anomaly detection image.

36. The method of any one of clauses 29 to 35, 1a, 1b or 1c, wherein the one or more characteristics comprise samples from the distribution.

37. The method of any one of clauses 29 to 36, 1a, 1b or 1c wherein the one or more characteristics comprise an upper and/or a lower quantile of the distribution.

38. The method of any one of clauses 29 to 37, 1a, 1b or 1c, wherein the one or more characteristics comprise moments of the distribution.

39. The method of any one of clauses 29 to 36, 1a, 1b or 1c, wherein the one or more characteristics comprise a minimum and/or maximum value of the domain of the distribution.

40. The method of any one of clauses 36 to 39, further providing filters for each defect class of the subset of the defect classes.

41. The method of clause 40, the filters comprising size filters.

42. The method of clause 40 or 41, wherein the set of calibration methods comprises a calibration method for calibrating the anomaly detection image by applying the following steps:
for each defect class of the subset of the defect classes, computing an intermediate calibrated image obtained by
   i. adapting the anomaly detection image values based on the one or more characteristics of the distribution of anomaly detection image values of the current defect class;
   ii. applying one or more filters of the current defect class;
generating the calibrated anomaly detection image by applying an operator to all intermediate calibrated images, the operator being selected from the group containing pixelwise sum, pixelwise average, pixelwise minimum, pixelwise maximum, pixelwise scaling.

43. The method of clause 42, wherein the anomaly detection image values are adapted by normalization.

44. The method of clause 42, wherein the anomaly detection image values are adapted by clipping.

45. The method of any one of clauses 29 to 44, 1a, 1b or 1c, wherein the set of calibration methods comprises a calibration method for calibrating the anomaly detection image by applying the following steps:
training a machine learning model for anomaly localization, such as anomaly segmentation, based on the one or more characteristics of the distributions of the anomaly detection image values for all defect classes of the subset of the defect classes;
applying the trained machine learning model to the anomaly detection image to obtain the calibrated anomaly detection image.

46. The method of clause 45, wherein the machine learning model is trained to optimize a loss function for anomaly localization based on foreground and background samples.

47. The method of clause 46, wherein the loss function is a weighted cross entropy loss function.

48. The method of clause 46, wherein the loss function is a Kullback-Leibler divergence loss function or an L₁ loss function or an L₂ loss function.

49. The method of any one of clauses 46 to 48, wherein the loss function is a semi-supervised loss function.

50. The method of any one of clauses 45 to 49, wherein the machine learning model for anomaly localization is trained on a partially labeled anomaly detection image derived from the characteristics of the distributions.

51. The method of any one of clauses 45 to 50, wherein the one or more characteristics comprise samples from the distributions, which are used as foreground or background samples.

52. The method of clause 51, wherein the samples are used as foreground samples and the background samples are selected from the remaining pixels of the anomaly detection image.

53. The method of clause 52, wherein a remaining pixel of the anomaly detection image is selected as background sample, if its anomaly detection image value lies below a threshold.

54. The method of clause 52 or 53, wherein each background sample is weighted by a weighting function w of its anomaly detection image value α, in particular by the negative exponential weighting function w(α)=exp(−α).

55. The method of any one of clauses 45 to 54, wherein the machine learning model is pre-trained on training data from a similar application.

56. The method of any one of clauses 45 to 55, wherein the machine learning model addresses class imbalance by using a focal loss function and/or defect rate priors.

57. The method of any one of clauses 29 to 56, 1a, 1b or 1c, further comprising presenting the anomaly detection image to a user via a user interface, the user interface being configured to let the user enter information on each defect class of the subset of the defect classes, from which the one or more characteristics of the distribution of the anomaly detection image values of each defect class are derived.

58. The method of clause 57, wherein the user interface is configured to let the user indicate the location of a small number of defects of each class of the subset of the defect classes in the anomaly detection image, and the one or more characteristics of the distribution of anomaly detection image values for each of these classes are provided by sampling anomaly detection image values from the defects indicated by the user for this class.

59. The method of clause 58, wherein the user indicates the location of a defect by selecting a single pixel, such as a pixel in the center region, of the defect.

60. The method of clause 59, wherein an annotation of the defect is automatically generated by selecting a region, such as a circle, surrounding the selected single pixel.

61. The method of clause 60, wherein the anomaly detection image values are sampled from the region surrounding the selected pixel.

62. The method of clause 60 or 61, wherein the region is selected based on application specific knowledge, in particular from the field of wafer manufacturing.

63. The method of clause 62, wherein the size of the region is selected based on the critical dimension.

64. The method of clause 62 or 63, wherein the size of the region is selected based on the pitch size.

65. The method of any one of clauses 29 to 64, 1a, 1b or 1c, wherein the calibrated anomaly detection image is postprocessed to further reduce nuisance.

66. The method of any one of clauses 29 to 65, 1a, 1b or 1c, wherein the one or more characteristics of the distribution of anomaly detection image values for each defect class of the subset of the defect classes are provided based on similar applications.

67. The method of any one of clauses 29 to 66, 1a, 1b or 1c, further generating an uncertainty estimate for each anomaly in the calibrated anomaly detection image.

68. The method of any one of clauses 29 to 67, 1a, 1b or 1c, further comprising a final step after carrying out the one or more iterations
Thresholding the calibrated difference image by a single threshold to obtain a binary anomaly detection image

69. The method any one of clauses 29 to 68, 1a, 1b or 1c, wherein the subset of the defect classes contains less than 50% of the defect classes, such as less than 30% of the defect classes, such as less than 20% of the defect classes, for example less than 10% of the defect classes.

70. The method of any one of the clauses 29 to 69, 1a, 1b or 1c, wherein the multiple iterations are executed and the calibration method differs for at least two iterations of the multiple iterations.

70a. The method of any one of the preceding clauses, wherein the imaging dataset comprises one or more multisensory images.

70b. The method of any one of the preceding clauses, wherein the imaging dataset comprises two-dimensional images, three-dimensional images, slice-wise three-dimensional images or multisensory-fusion images.

71. The method of any one of the preceding clauses, wherein the imaging dataset is a multibeam SEM image.

72. The method of any one of the preceding clauses, wherein the imaging dataset is a focused ion beam SEM image.

73. The method of any one of the preceding clauses, further comprising measuring one or more properties of the detected anomalies.

74. The method of clause 73, further controlling at least one wafer manufacturing process parameter based on the one or more measured properties.

75. The method of clause 73, further comprising assessing the quality of the wafer based on the one or more measured properties and at least one quality assessment rule.

76. One or more machine-readable hardware storage devices comprising instructions that are executable by one or more processing devices to perform operations comprising the method of any one of clauses 1 to 75.

77. A system for controlling the quality of wafers produced in a semiconductor manufacturing fab, the system comprising
an imaging device adapted to provide an imaging dataset of the wafer;
one or more processing devices;
one or more machine-readable hardware storage devices comprising instructions that are executable by one or more processing devices to perform operations comprising the method of clause 75.

78. A system for controlling the production of wafers in a semiconductor manufacturing fab, the system comprising
A mechanism for producing wafers controlled by at least one manufacturing process parameter;
an imaging device adapted to provide an imaging dataset of the wafers;
one or more processing devices;
one or more machine-readable hardware storage devices comprising instructions that are executable by one or more processing devices to perform operations comprising the method of clause 74.

79. Computer implemented method for the detection of anomalies comprising:
Selecting an imaging dataset of a wafer;
Generating training data from the imaging dataset;
Iterating the following steps:
   i. Selecting a hyperparameter value from an associated set of hyperparameter values, based on a sampling strategy, the hyperparameter value corresponding to at least one hyperparameter that defines a machine learning model for the detection of anomalies;
   ii. Training the machine learning model defined by the hyperparameter based on a subset of the generated training data;
   iii. Evaluating the trained machine learning model by computing an associated objective function value of an objective function;
Selecting one of the trained machine learning models based on the associated objective function value and applying it to the imaging dataset of a wafer to detect anomalies.

80. The method of clause 79, wherein the machine learning model when presented with a subset of the imaging dataset as input is trained to compute a reconstruction of the subset without anomalies, and the anomalies within the subset are detected based on a comparison between the subset and the reconstructed subset.

81. The method of clause 80, wherein the machine learning model comprises an autoencoder.

82. The method of any one of clauses 79 to 81, wherein at least one hyperparameter is related to the design of the machine learning model.

83. The method of any one of clauses 79 to 82, wherein the objective function comprises at least two different model evaluation metrics.

84. The method of clause 83, wherein one of the model evaluation metrics comprises the loss function used during training of the machine learning model.

85. The method of clause 83 or 84, wherein one of the model evaluation metrics comprises an Lp-norm loss function, p≥1.

86. The method of any one of clauses 83 to 85, wherein the training data comprises expert annotations of anomalies for subsets of the imaging dataset, and one of the model evaluation metrics comprises a discriminative loss function evaluating the difference between the expert annotations of the anomalies and the detected anomalies.

87. The method of clause 86, wherein the expert annotations contain only a subset of the anomalies present in the imaging dataset.

88. The method of any one of clauses 83 to 87, wherein one of the model evaluation metrics comprises a measure of the complexity of the machine learning model.

89. The method of clause 88, wherein the measure of the complexity of the machine learning model considers the total number of floating-point operations in one forward-pass of the machine learning model.

90. The method of any one of clauses 79 to 89, wherein the training data comprises expert annotations of anomalies for subsets of the imaging dataset, and the objective function comprises a weighted sum of an Lp-norm loss function, p≥1, a discriminative loss function evaluating the difference between the expert annotations of the anomalies and the detected anomalies and a measure of the complexity of the machine learning model.

91. The method of any one of clauses 79 to 90, wherein the objective function comprises a quality value to evaluate the quality of the trained machine learning model, wherein a user interface is configured to present information on the trained machine learning model to a user and let the user indicate the quality value.

92. The method of any one of clauses 79 to 91, wherein the sampling strategy for selecting the number of hyperparameter values comprises taking into account hyperparameter values and corresponding values of the objective function from one or more previous iterations by optimizing one criterion selected from the group comprising expected improvement, maximum probability of improvement, upper confidence bound.

93. The method of any one of clauses 79 to 92, wherein the sampling strategy comprises an early stopping criterion.

94. The method of any one of clauses 79 to 93, wherein at least one set of hyperparameter values is associated with a probability distribution indicating the likelihood for each hyperparameter value for being selected by the sampling strategy.

95. The method of clause 94, wherein the probability distribution is modeled based on prior application based knowledge, such as based on imaging hardware settings or design knowledge such as critical distance, critical dimension or pitch size.

96. The method of any one of clauses 79 to 95, wherein the sampling strategy differs for at least two iterations.

97. The method of any one of clauses 79 to 96, wherein the size of the subset of the generated training data increases with the number of iterations.

98. Computer implemented method for the detection of anomalies in an imaging dataset of a wafer, the imaging dataset comprising defects belonging to a number of defect classes, the method comprising:
Generating an anomaly detection image by applying an anomaly detection method to an imaging dataset;
Performing one or more iterations, at least one of them comprising the following steps
   i. Providing one or more samples of a distribution of anomaly detection image values for each defect class of a subset of the defect classes;
   ii. Calibrating the anomaly detection image via at least one calibration method comprising the following steps:
      a. Training a machine learning model for anomaly localization, pr such as anomaly segmentation, based on the one or more samples of the distribution of the anomaly detection image values;
      b. Applying the trained machine learning model to the anomaly detection image to obtain the calibrated anomaly detection image;
Applying a threshold to the calibrated anomaly detection image to detect anomalies, thereby reducing nuisance and highlighting defects in the anomaly detection image.

99. The method of clause 98, wherein the anomaly detection image is a difference image of the imaging dataset and a comparison dataset, the comparison dataset being based on a die-to-die principle or on a die-to-database principle.

100. The method of clause 99, wherein the comparison dataset comprises a reconstructed representation of the imaging dataset generated by training a machine learning autoencoder on the imaging dataset or a subset thereof and applying the trained autoencoder to the imaging dataset to obtain the reconstructed representation.

101. The method of any one of clauses 98 to 100, wherein the machine learning model for anomaly localization is trained to optimize a loss function based on foreground and background samples.

102. The method of clause 101, wherein the loss function is a semi-supervised loss function.

103. The method of clause 101 or 102, wherein the samples from the distributions of anomaly detection image values for each defect class of a subset of the defect classes are used as foreground or background samples.

104. The method of clause 103, wherein the samples are used as foreground samples and the background samples are selected from the remaining pixels of the anomaly detection image.

105. The method of clause 104, wherein a remaining pixel of the anomaly detection image is selected as background sample, if its anomaly detection image value lies below a threshold.

106. The method according to clause 104 or 105, wherein each background sample is weighted by a weighting function w of its anomaly detection image value α, in particular by the negative exponential weighting function w(α)=exp(−α).

107. The method of any one of clauses 98 to 106, wherein the user interface is configured to let the user indicate the location of a small number of defects of each class of the subset of the defect classes in the anomaly detection image, wherein the user indicates the location of a defect by selecting a single pixel, such as a pixel in the center region, of the defect and an annotation of the defect is automatically generated by selecting a region, such as a circle, surrounding the selected single pixel, and the anomaly detection image values are sampled from the region surrounding the selected pixel.

108. The method of clause 107, wherein the size of the region is selected based on the critical dimension and/or the critical distance and/or on the pitch size.

109. The method of any one of clauses 79 to 108, wherein the imaging dataset comprises one or more multisensory images.

110. The method of any one of clauses 79 to 109, wherein the imaging dataset is a multibeam SEM image.

111. The method of any one of clauses 79 to 110, wherein the imaging dataset is a focused ion beam SEM image.

112. The method of any one of clauses 79 to 111, further comprising measuring one or more properties of the detected anomalies.

113. The method of clause 112, further controlling at least one wafer manufacturing process parameter based on the one or more measured properties.

114. The method of clause 112, further comprising assessing the quality of the wafer based on the one or more measured properties and at least one quality assessment rule.

115. One or more machine-readable hardware storage devices comprising instructions that are executable by one or more processing devices to perform operations comprising the method of any one of clauses 79 to 114.

116. A system for controlling the quality of wafers produced in a semiconductor manufacturing fab, the system comprising
an imaging device adapted to provide an imaging dataset of the wafer;
one or more processing devices;
one or more machine-readable hardware storage devices comprising instructions that are executable by one or more processing devices to perform operations comprising the method of clause 114.

117. A system for controlling the production of wafers in a semiconductor manufacturing fab, the system comprising
A mechanism for producing wafers controlled by at least one manufacturing process parameter;
an imaging device adapted to provide an imaging dataset of the wafers;
one or more processing devices;
one or more machine-readable hardware storage devices comprising instructions that are executable by one or more processing devices to perform operations comprising the method of clause 113.

In summary, certain features of the disclosure include: The disclosure relates to a computer implemented method 10, 10′ for the detection of anomalies 15 comprising: selecting an imaging dataset 12 of a wafer 120 and a hyperparameter value defining a machine learning model 16 for anomaly detection; training and evaluating the machine learning model 16 by computing an objective function value; selecting one of the trained machine learning models and applying it to detect anomalies 15. The disclosure also relates to a computer implemented method 10″ for the detection of anomalies 15 in an imaging dataset 12 of a wafer 120 comprising: providing samples of a distribution of anomaly detection image values for each defect class; calibrating the anomaly detection image 20, 26, 26′ by training a machine learning model for anomaly localization; applying a threshold to the calibrated anomaly detection image 98, 108 to detect anomalies 15.

### REFERENCE NUMBER LIST

10, 10′, 10″, 10″′ Computer implemented method
11 Defective cell structure
12 Imaging dataset
14 Input
15 Anomaly
16 Machine learning model
18 Reconstruction
19 Data selection step
20 Anomaly detection image
21 Training data generation step
22, 22′ Input image
23 Defect
24, 24′ Reconstruction image
25 Hyperparameter value selection step
26, 26′ Anomaly detection image
27 Training step
28, 28′ Anomaly detection image
29 Model evaluation step
30, 30′ Input image
31 Model selection step
32, 32′ Reconstruction image
34 Defect-free data
36 Expert annotations
38 Expert knowledge
40 Hyperparameter ranges
42 Sampler
43 Hyperparameter optimization unit
44 Pruner
46 Objective function
48 Hyperparameter
50 Subsampled dataset
52 Full imaging dataset
54 Optimized model
56 Final model
58 Good group
60 Bad group
61 Anomaly detection image generation step
62 Density of good group
63 Sampling step
64 Density of bad group
65 Calibration step
66 Expected improvement
67 Training step
68 Worst trial
69 Application step
70 Best trial
71 Thresholding step
72 Anomaly detection image
73 Iterations
74 Calibration step
76 Evaluation step
77 Positive answer
78 Termination step
79 Negative answer
80 Calibration method adaptation step
82 Threshold or filter adjustment step
84 Annotation adjustment step
86 Training step
88 Iteration
90 Input image
92 Anomaly detection image
94 Click points
95 Partially annotated anomaly detection image
96 Annotations
98 Calibrated anomaly detection image
100 Overlay
102 Reconstruction image
104 Input image
106 Uncalibrated anomaly detection image
108 Calibrated anomaly detection image
110 Confusion matrix before calibration
112 Confusion matrix after calibration
114, 114′ System
116 Imaging device
118 Processing device
120 Wafer
122 CPU
124 Interface
126 Memory
128 User interface
130 Mechanism

1. A computer implemented method, comprising:
a) generating training data from an imaging dataset of a wafer;
b) iteratively:
i) selecting a hyperparameter value from an associated set of hyperparameter values based on a sampling strategy, the hyperparameter value corresponding to at least one hyperparameter defining a machine learning model for detecting anomalies;
ii) training the machine learning model defined by the hyperparameter based on a subset of the generated training data; and
iii) evaluating the trained machine learning model by computing an associated objective function value of an objective function; and
c) after b), selecting one of the trained machine learning models based on the associated objective function value and applying it to the imaging dataset of a wafer to detect anomalies.

2. The method of claim 1, wherein the machine learning model is trained so that, when presented the machine learning model is presented with a subset of the imaging dataset as input, the machine learning model computes a reconstruction of the subset without anomalies, and the anomalies within the subset are detected based on a comparison between the subset and the reconstructed subset.

3. The method of claim 1, wherein at least one hyperparameter comprises a design hyperparameter related to the design of the machine learning model.

4. The method of claim 1, wherein all of the hyperparameters comprise design hyperparameters related to the design of the machine learning model.

5. The method of claim 1, wherein the objective function comprises at least two different model evaluation metrics.

6. The method of claim 1, wherein the training data comprises expert annotations of anomalies for subsets of the imaging dataset, and the objective function comprises a weighted sum of an Lp-norm loss function, p≥1, of the training data samples, corresponding target data samples and a discriminative loss function evaluating the difference between the expert annotations of the anomalies.

7. The method of claim 1, wherein the objective function comprises a quality value to evaluate the quality of the trained machine learning model, and a user interface is configured to present information on the trained machine learning model to a user and let the user indicate the quality value.

8. The method of claim 1, wherein the sampling strategy for selecting the number of hyperparameter values comprises taking into account hyperparameter values and corresponding values of the objective function from one or more previous iterations by optimizing one criterion selected from the group consisting of expected improvement, maximum probability of improvement, and upper confidence bound.

9. The method of claim 1, wherein the sampling strategy comprises an early stopping criterion.

10. The method of claim 1, wherein at least one set of hyperparameter values is associated with a probability distribution indicating a likelihood for each hyperparameter value being selected by the sampling strategy.

11. The method of claim 1, wherein the sampling strategy differs for at least two iterations.

12. The method of claim 1, wherein a size of the subset of the generated training data increases with the number of iterations.

13. The method of claim 1, wherein the imaging dataset comprises a multisensory image.

14. The method of claim 1, wherein the imaging dataset comprises a member selected from the group consisting of a multibeam SEM image and a focused ion beam SEM image.

15. The method of claim 1, further comprising measuring a property of the detected anomalies.

16. One or more machine-readable hardware storage devices comprising instructions that are executable by one or more processing devices to perform operations comprising the method of claim 1.

17. A system, comprising:
one or more processing devices; and
one or more machine-readable hardware storage devices comprising instructions that are executable by one or more processing devices to perform operations comprising the method of claim 1.

18. The system of claim 17, further comprising an imaging device configured to provide the imaging data set of the wafer.

19. The system of claim 18, further comprising a mechanism configured to produce the wafer.

20. A computer implemented method to detect anomalies in an imaging dataset of a wafer, the imaging dataset comprising defects belonging to a plurality of defect classes, the method comprising:
A) generating an anomaly detection image by applying an anomaly detection method to the imaging dataset;
B) performing one or more iterations comprising:
i. providing one or more samples of a distribution of anomaly detection image values for each defect class of a subset of the defect classes; and
ii. calibrating the anomaly detection image using at least one calibration method comprising:
a. training a machine learning model for anomaly localization based on the one or more samples of the distributions of the anomaly detection image values; and
b. applying the trained machine learning model to the anomaly detection image to obtain the calibrated anomaly detection image; and
C) after B), applying a threshold to the calibrated anomaly detection image to detect anomalies to reduce nuisance and highlighting defects in the anomaly detection image.

21.-28. (canceled)
